(19) United States
(12) Patent Application Publication
(10) Pub. No.: US 2024/0213622 A1
(43) Pub. Date: Jun. 27, 2024

(54) Separator for Energy Storage Device

(71) Applicant: Asahi Kasei Kabushiki Kaisha, Tokyo (JP)

(72) Inventors: Mayu Kidena, Tokyo (JP); Yoshitaka Nakagawa, Tokyo (JP)

(73) Assignee: Asahi Kasei Kabushiki Kaisha, Tokyo (JP)

(21) Appl. No.: 18/396,953

(22) Filed: Dec. 27, 2023

(30) Foreign Application Priority Data
Dec. 27, 2022 (JP) 2022-210935
Nov. 27, 2023 (JP) 2023-199663

(51) Int. Cl. H01M 50/451; H01M 50/42; H01M 50/434; H01M 50/457; H01M 50/494

(52) U.S. Cl. CPC H01M 50/451; H01M 50/42; H01M 50/434; H01M 50/457; H01M 50/494

(57) ABSTRACT

[PROBLEM] An object of the present invention is to provide a separator for an energy storage device having excellent pin removal properties when pulling out a pin from a wound body with an electrode, a method for the production of the separator, or an energy storage device including the same.

[SOLUTION] Provided is a separator for an energy storage device, including a porous substrate, an inorganic filler-containing layer arranged on only one face of the porous substrate, and a thermoplastic polymer-containing layer arranged on a surface of the inorganic filler-containing layer, wherein a coefficient of dynamic friction μ′_{α} between a surface on the porous substrate side and stainless steel (SUS304) and a coefficient of dynamic friction μ′_{β} between a surface on the inorganic filler-containing layer side and a lithium metal oxide-containing face of a predetermined positive electrode f satisfy the following relationship:

$$μ ’ α / μ ’ β < 1. .$$

### TECHNICAL FIELD

The present invention relates to a separator for an energy storage device, a method for the production or use thereof, and an energy storage device.

### BACKGROUND ART

In recent years, energy storage devices such as non-aqueous electrolyte batteries have been actively developed. Conventionally, in non-aqueous electrolyte batteries such as lithium-ion batteries, a microporous membrane is provided as a separator between the positive and negative electrodes. Such a separator has the function of preventing direct contact between the positive and negative electrodes and allowing ions to pass through the electrolyte solution held in the micropores thereof.

Safety such as the characteristic wherein the battery reaction stops immediately in case of abnormal heating (fuse characteristic) and the characteristic to maintain shape even at high temperatures and prevent dangerous situations where the positive and negative electrode materials react directly (short-circuit characteristics) has long been required for separators.

In recent years, the performance of electronic devices such as laptop personal computers, mobile phones, digital cameras, and in-vehicle accessories has increased significantly, and in accordance therewith, there is a need for wound batteries or cylindrical batteries. For example, Patent Literature 1 illustrates the start and completion of a winding step in which a separator and an electrode are wound around a core in the production of a lithium secondary battery.

Conventionally, the production of wound batteries or cylindrical batteries has problems such as pin removal defects when a separator and an electrode are wound around a pin to create a wound body, for example, shape loss of an area around a pin of a wound body by protrusion in a conical manner, winding collapse and step shift of the wound body, and deformation of the ends of the wound body.

To solve the problems, conventionally, attention has been focused mainly on the frictional properties, surface properties, or surface coating of microporous membranes (Patent Literature 2 to 5).

For example, Patent Literature 2 describes a separator for a lithium-ion secondary battery with an alloy-based negative electrode, wherein a dynamic friction coefficient of at least one face is 0.1 or more and 0.4 or less from the viewpoint of suppressing decline in permeation performance due to no or alleviated collapse of the surface layer of the separator for lithium-ion secondary batteries when used in combination with alloy-based negative electrode materials, as well as the viewpoint of improving pin removal properties in a battery winding step.

Patent Literature 3 describes a polyolefin microporous membrane having a compressive modulus of 0.1 to 1000 kPa and a ratio of the tensile modulus in the longitudinal direction to the tensile modulus in the width direction of 1.5 to 7.8, wherein the coefficient of dynamic friction between the contact elements, which are made by winding 20 strands of piano wire having an area of 100 mm² and a diameter of 0.5 mm, is 0.2 to 0.7, from the viewpoint of providing excellent winding stability in the production or processing line of the polyolefin microporous membrane and in the battery winding process line, and preventing a step shift or a winding shift upon impact on the wound body.

Patent Literature 4 describes a microporous membrane containing copolymerized high-density polyethylene and high-density polyethylene, wherein the content of α-olefin units having 3 or more carbon atoms is 0.01 mol % or more and 0.6 mol % or less, the viscosity average molecular weight of the microporous membrane is less than 300,000, and the coefficient of dynamic friction of the microporous membrane is less than 0.2, from the viewpoint of superior battery safety and productivity in light of the problem of pin removal defects or heat generation inside the battery.

Patent Literature 5 describes a battery separator comprising a polyolefin microporous membrane and a porous layer with which at least one face of the polyolefin microporous membrane is coated and that alumina particles at 50% by volume or more relative to the alumina particles and a binder contained in the porous layer were investigated for the disappearance temperature of a specific peak in Fourier transform infrared spectroscopy, the two maxima of the primary particle size distribution, and the volume ratio according to the particle size.

### CITATIONS LIST

### Patent Literature

[PTL 1] Japanese Unexamined Patent Publication (Kokai) No. 2004-253381
[PTL 2] WO 2008/059806
[PTL 3] WO 2010/073707
[PTL 4] WO 2017/010528
[PTL 5] WO 2018/021143

### SUMMARY OF INVENTION

### Technical Problem

In recent years, there has been an increasing demand for thin separators to improve the capacity of non-aqueous electrolyte batteries. In particular, there is a strong demand for thickness reduction not only in separator substrates and single-layer microporous membranes, but also stacked, multilayered, or coated separators.

However, thin membrane separators are generally less rigid and more prone to wrinkling than thick membrane separators, which may result in poor pin removal properties.

In light of the above circumstances, an object of the present invention is to provide a separator for an energy storage device which has excellent pin removal properties when pulling out a pin from a wound body with an electrode, a method for the production or use of the separator, or an energy storage device including the same.

### Solution to Problem

As a result of rigorous investigation, the present inventors have discovered that the problems described above can be solved by a separator for an energy storage device having the following configurations, and have completed the present invention. A part of the aspects of the invention are listed below.

(Item 1) A separator for an energy storage device, comprising: a porous substrate, an inorganic filler-containing layer arranged on only one face of the porous substrate, and a thermoplastic polymer-containing layer arranged on a surface of the inorganic filler-containing layer, wherein a coefficient of dynamic friction μ′_{α} between a surface on the porous substrate side and stainless steel (SUS304) and a coefficient of dynamic friction μ′_{β} between a surface on the inorganic filler-containing layer side and a lithium metal oxide-containing face of a predetermined positive electrode f satisfy the following relationship:

$$μ ’ α / μ ’ β < 1. .$$

(Item 2) A separator for an energy storage device, comprising: a porous substrate, an inorganic filler-containing layer arranged on only one face of the porous substrate, and
thermoplastic polymer-containing layers arranged on a surface of the porous substrate and a surface of the inorganic filler-containing layer, wherein a coefficient of dynamic friction μ′_{α} between a surface on the porous substrate side and stainless steel (SUS304) and a coefficient of dynamic friction μ′_{β} between a surface on the inorganic filler-containing layer side and a lithium metal oxide-containing face of a predetermined positive electrode f satisfy the following relationship:

$$μ ’ α / μ ’ β < 1. .$$

(Item 3) The separator for an energy storage device according to Item 1 or 2, wherein μ′_{β} satisfies the following relationship:

$$μ ’ β > 0.50 .$$

(Item 4) The separator for an energy storage device according to any one of Items 1 to 3, wherein a thermoplastic polymer contained in the thermoplastic polymer-containing layer has a loss tangent (tan δ value) of 0.01 or more and 0.05 or less at 30° C. in dynamic viscoelasticity measurement at 1 Hz.

(Item 5) The separator for an energy storage device according to any one of Items 1 to 4, wherein a maximum value of a loss tangent (tan δ value) of the thermoplastic polymer contained in the thermoplastic polymer-containing layer is at 70° C. or higher in dynamic viscoelasticity measurement at 1 Hz.

(Item 6) The separator for an energy storage device according to any one of Items 1 to 5, wherein a total coverage area ratio of the thermoplastic polymer-containing layer relative to the porous substrate is 10% or more and 70% or less.

(Item 7) The separator for an energy storage device according to any one of Items 1 to 6, wherein the thermoplastic polymer-containing layer is arranged in a dot-like pattern on the surface of the porous substrate and the surface of the inorganic filler-containing layer.

(Item 8) The separator for an energy storage device according to any one of Items 1 to 7, wherein particles constituting the thermoplastic polymer-containing layer have a volume average particle diameter D50 of 100 nm or more and 800 nm or less.

(Item 9) The separator for an energy storage device according to any one of Items 1 to 8, wherein a thermoplastic polymer constituting the thermoplastic polymer-containing layer has at least two glass transition temperatures,
at least one of the glass transition temperatures is present in a region of lower than 20° C., and
at least one of the glass transition temperatures is present in a region of 30° C. or higher.

(Item 10) The separator for an energy storage device according to any one of Items 1 to 9, wherein the thermoplastic polymer-containing layer comprises a copolymer containing a monomer unit of a (meth)acrylic acid ester monomer.

(Item 11) The separator for an energy storage device according to any one of Items 1 to 10, wherein an inorganic filler constituting the inorganic filler-containing layer has a volume average particle diameter D50 of 0.5 μm or less.

(Item 12) The separator for an energy storage device according to any one of Items 1 to 11, wherein a ratio (MD/TD tensile breaking strength ratio) of an MD tensile breaking strength to a TD tensile breaking strength of the separator for an energy storage device is 0.5 or more and 1.5 or less.

(Item 13) The separator for an energy storage device according to any one of Items 1 to 12, wherein a thickness of the separator for an energy storage device is 16 μm or less.

(Item 14) An energy storage device comprising a positive electrode, a negative electrode, the separator for an energy storage device according to any one of Items 1 to 13, and a non-aqueous electrolyte solution.

### Advantageous Effects of Invention

According to the present invention, the pin removal properties when pulling out the pin from a wound body formed by winding a separator for an energy storage device and an electrode around a pin are excellent, and the pin removal properties are excellent even for thin membrane separators, whereby in the production of a separator for an energy storage device and an energy storage device comprising the same, productivity and economy are excellent, and the capacity of the energy storage device can also be improved.

### BRIEF DESCRIPTION OF DRAWINGS

FIG. 1 is a schematic cross-sectional view illustrating a wound state when a separator for an energy storage device, a positive electrode, and a negative electrode are wound around a pin to form a wound body according to an embodiment of the present invention.

FIG. 2A is a schematic diagram showing the overall configuration of a manual winding device, and FIG. 2B is a schematic diagram showing the configuration of a winding section of the manual winding device.

### DESCRIPTION OF EMBODIMENT

Hereinafter, the embodiment for carrying out the present invention (hereinafter referred to as “the present embodiment”) will be described in detail. It should be noted that the present invention is not limited to the following embodiments, and can be carried out with various modifications within the scope of the spirit thereof.

Furthermore, unless otherwise specified, the characteristic values in the present embodiment are values measured by the methods described in the Examples section or methods understood by a person skilled in the art to be equivalent thereto.

In the following description, upper limit values or lower limit values in numerical ranges described in a stepwise manner may be replaced with other upper limit values or lower limit values in numerical ranges described in a stepwise manner. Further, in the following description, the upper limit or lower limit of a certain numerical range may be replaced with the values described in the Examples. Furthermore, regarding the term “step” in the following description, not only an independent step but also a step that cannot be clearly distinguished from other steps can be included in the term as long as the function of the “step” is achieved.

In this specification, the longitudinal direction (MD) means the machine direction in continuous molding of the microporous membrane, and the transverse direction (TD) means the direction crossing the MD of the microporous membrane at an angle of 90°.

### <Separator for Energy Storage Device>

The separator for an energy storage device (hereinafter also referred to simply as “separator”) according to the present embodiment comprises a porous substrate, an inorganic filler-containing layer arranged on one face of the porous substrate, and a thermoplastic polymer-containing layers arranged on a surface of the porous substrate and a surface of the inorganic filler-containing layer. Furthermore, the separator for an energy storage device according to the present application may comprise a porous substrate, an inorganic filler-containing layer arranged on one face of the porous substrate, and a thermoplastic polymer-containing layer arranged on only a surface of the inorganic filler-containing layer.

### [Relationship Between Separator and Friction Coefficient]

In the separator according to the present embodiment, a coefficient of dynamic friction μ′_{α} between a surface on the porous substrate side and stainless steel (SUS304) or a coefficient of dynamic friction μ′_{α} between the thermoplastic polymer-containing layer on a surface of the porous substrate and stainless steel (SUS304) and a coefficient of dynamic friction μ′_{β} between a surface on the inorganic filler-containing layer side and a lithium metal oxide-containing face of a predetermined positive electrode f or a coefficient of dynamic friction μ′_{β} between the thermoplastic polymer-containing layer on the surface of the inorganic filler-containing layer and a lithium metal oxide-containing face of a predetermined positive electrode f satisfy the following relationship:

$$μ ’ α / μ ’ β < 1. .$$

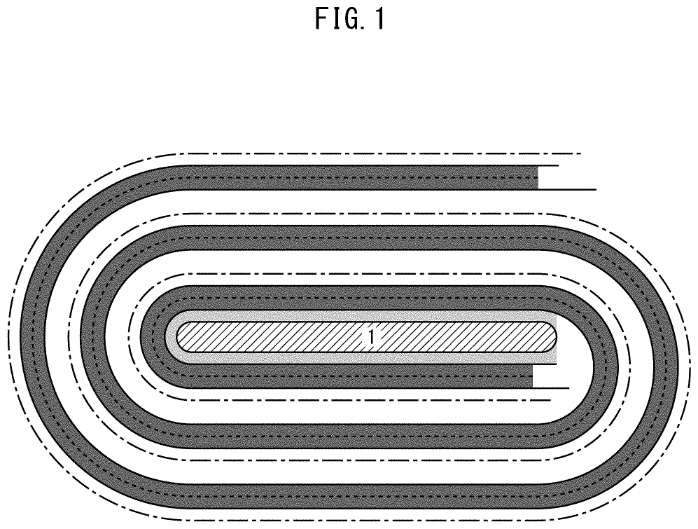

FIG. 1 is a schematic cross-sectional view illustrating a wound state when a separator according to the present embodiment, a positive electrode, and a negative electrode are wound around a pin to form a wound body. Since FIG. 1 is a schematic cross-sectional view, the present invention is not intended to be limited to the form shown in drawing. FIG. 1 shows a wound state of a stack of a separator (solid line)-positive electrode (dotted line)-separator (solid line)-negative electrode (dash-dot line) stacked in this order on a flat pin (1). With reference to FIG. 1, the separator according to the present embodiment and the mechanism of action thereof will be described below.

In general, since the flat pin (1) is made of stainless steel (SUS) such as SUS430, 304, 201, or 600 in accordance with the JIS standard, the coefficient of dynamic friction μ′_{α} between a surface of the separator on the porous substrate side and stainless steel (SUS304) or the coefficient of dynamic friction μ′_{α} between the thermoplastic polymer-containing layer on a surface of the porous substrate of the separator and stainless steel (SUS304) can be understood as the coefficient of dynamic friction between the porous substrate of the separator or the thermoplastic polymer-containing layer on the surface of the porous substrate and the flat pin (1) (light gray area a).

Since it is known in the relevant technical field that a positive electrode is formed by, for example, applying an application liquid containing a positive electrode active material represented by a lithium metal oxide or a lithium metal phosphate compound such as LCO, LMO, (L)NMC, NCA, LFP, and LFMP and a binder resin to a positive electrode current collector, the coefficient of dynamic friction μ′_{β} between a surface of the separator on the inorganic filler-containing layer side and a lithium metal oxide-containing face of a predetermined positive electrode f or the coefficient of dynamic friction μ′_{β} between the thermoplastic polymer-containing layer on the surface of the inorganic filler-containing layer and a lithium metal oxide-containing face of a predetermined positive electrode f can be understood as the coefficient of dynamic friction between the thermoplastic polymer-containing layer and the positive electrode (dark gray area P). In FIG. 1, since there are two separators (solid lines) in the form of membranes, two regions P are shown facing each other with the positive electrode (dotted line) therebetween. The positive electrode f can be obtained in accordance with, for example, the production conditions and production method for a positive electrode f for measuring the coefficient of dynamic friction μ′_{β} described in the Examples.

The separator (solid line) which satisfies μ′_{α}/μ′_{μ}<1.00 can facilitate removal of the pin (1) when removed from the wound body by keeping the friction coefficient between the flat pin (1) and the separator (solid line) below a certain value, and can suppress or prevent pin removal defects by, for example, increasing the coefficient of friction between an electrode such as a positive electrode (dotted line) and a separator (solid line) to a value greater than a certain value. Pin removal defects refers to problems such as shape loss of an area around a pin of a wound body by protrusion in a conical manner, winding collapse and step shift of the wound body, and deformation of the ends of the wound body.

In the separator according to the present embodiment, from the viewpoint of further improving the pin removal properties, the coefficient of dynamic friction μ′_{α} and the coefficient of dynamic friction μ′_{β} more preferably satisfy the following relationship

$$μ ’ α / μ ’ β < 0.9 .$$

From the viewpoint of improving the pin removal properties and friction control in the separator, i.e., satisfying μ′_{α}/μ′_{β}<1.00, in the separator, the coefficient of dynamic friction μ′_{β} between a surface on the inorganic filler-containing layer side and a lithium metal oxide-containing face of a predetermined positive electrode f or the coefficient of dynamic friction μ′_{β} between the thermoplastic polymer-containing layer on the surface of the inorganic filler-containing layer and a lithium metal oxide-containing face of a predetermined positive electrode f preferably satisfies the following relationship:

$$μ ’ β > 0.50 .$$

more preferably satisfies the following relationship:

$$0.51 \leq μ ’ β \leq 1. ,$$

further preferably satisfies the following relationship:

$$0.51 \leq μ ’ β \leq 0.8 ,$$

particularly preferably satisfies the following relationship:

$$0.51 \leq μ ’ β \leq 0.7 ,$$

most preferably satisfies the following relationship:

$$0.51 \leq μ ’ β \leq 0.6 ,$$

From the viewpoint of holding the pin during winding and facilitating removal when pulling out the pin from the wound body, and from the viewpoint of friction control of the separator, i.e., satisfying μ′_{α}/μ′_{β}<1.00, the coefficient of dynamic friction μ′_{α} between a surface of the separator on the porous substrate side and stainless steel (SUS304) or the coefficient of dynamic friction μ′_{α} between the thermoplastic polymer-containing layer on the surface of the porous substrate of the separator and stainless steel (SUS304) preferably satisfies the following relationship:

$$0.3 \leq μ ’ α \leq 0.7 ,$$

more preferably satisfies the following relationship:

$$0.37 < μ ’ α \leq 0.65 ,$$

further preferably satisfies the following relationship:

$$0.37 < μ ’ α \leq 0.6 ,$$

particularly preferably satisfies the following relationship:

$$0.41 < μ ’ α \leq 0.5 ,$$

most preferably satisfies the following relationship:

$$0.42 < μ ’ α \leq 0.48 .$$

The coefficient of dynamic friction of the separator μ′_{α} or μ′_{β} and μ′_{α}/μ′_{β}<1.00 can be controlled by, for example, in the separator production process, the configuration of the separator, the selection of the polymer raw materials or resin design based on the dynamic viscoelasticity and the particle size of the thermoplastic polymer, the selection or design of the inorganic filler, the optimization of the design of the porous substrates, and the application form of the thermoplastic polymer layer to the porous substrate or the inorganic filler-containing layer.

Regarding the layer configuration of the separator, the position of the inorganic filler-containing layer is at least a portion of the porous substrate surface, at least a portion of the thermoplastic polymer-containing layer surface, and/or between the porous substrate and the thermoplastic polymer-containing layer. The separator of the present embodiment may comprise an inorganic filler-containing layer on one or both faces of the porous substrate, and from the viewpoint of improving the pin removal properties and friction control as described above, and from the viewpoint of winding the separator and electrode as shown in FIG. 1, the inorganic filler-containing layer is preferably provided on one face of the porous substrate and between the porous substrate and the thermoplastic polymer-containing layer.

From the viewpoint of the mechanism of action of the present invention, the separator preferably has an asymmetric layer configuration on both faces relative to the porous substrate. For example, the presence or absence, structure, composition, and arrangement of the inorganic filler-containing layer, or the presence or absence, structure, composition, and arrangement of the thermoplastic polymer-containing layer may be determined so that a predetermined pattern of thermoplastic polymer-containing layers can be provided on both sides of the porous substrate, and an inorganic filler-containing layer can be provided between one face of the porous substrate and the thermoplastic polymer-containing layer. The exposed form or covered form of the thermoplastic polymer-containing layer may be different on both sides of the separator.

The constituent elements of the separator according to the present embodiment will be described below.

### [Porous Substrate]

Since insulation and ion permeability are necessary for the separator, the separator substrate is generally formed from an insulating material having a porous structure, such as paper, polyolefin nonwoven fabric, or resin microporous membrane. It is preferable that the porous substrate have a structure optimized from the viewpoint of friction control as described above. In particular, it is preferable that a polyolefin microporous membrane which has redox resistance and which can form a dense and uniform porous structure be used as the separator substrate used in energy storage devices such as non-aqueous secondary batteries, which comprise a positive electrode and a negative electrode that can absorb and release lithium, and a non-aqueous electrolyte solution prepared by dissolving an electrolyte in a non-aqueous solvent.

### (Polyolefin Microporous Membrane)

The polyolefin microporous membrane of the present embodiment is not particularly limited, is, for example, a microporous membrane configured of a polyolefin resin composition containing a polyolefin, and a microporous membrane containing polyolefin resin as a main component is preferred. In the polyolefin microporous membrane of the present embodiment, the content of polyolefin resin is not particularly limited, and from the viewpoint of shutdown performance when used as a separator for an energy storage device, a microporous membrane composed of a polyolefin resin composition in which polyolefin resin accounts for 50% or more and 100% or less of the weight fraction of all components constituting the microporous membrane is preferable. The proportion occupied by the polyolefin resin is more preferably 60% or more and 100% or less, and further preferably 70% or more and 100% or less.

The polyolefin resin is not particularly limited, and a polyolefin resin which can be used in convention extrusion, injection, inflation, or blow molding is sufficient, and homopolymers and copolymers, multistage polymers, etc., of ethylene, propylene, 1-butene, 4-methyl-1-pentene, 1-hexene, and 1-octene can be used. A polyolefin selected from the group consisting of these homopolymers, copolymers, and multistage polymers can be used alone or in combination.

Representative examples of polyolefin resins include, but are not particularly limited to, polyethylenes such as low-density polyethylene, linear low-density polyethylene, medium density polyethylene, high density polyethylene, ultra-high molecular weight polyethylene, polypropylenes such as isotactic polypropylene and atactic polypropylene, ethylene-propylene random copolymers, polybutene, and ethylene propylene rubber.

When the separator of the present embodiment is used as a battery separator, it is preferable to use polyethylene as the main component because it has a low melting point and high strength, and it is preferable that a resin containing high-density polyethylene as a main component be used.

Further, from the viewpoint of improving the heat resistance of the microporous membrane, it is more preferable that a microporous membrane composed of a resin composition containing polypropylene and a polyolefin resin other than polypropylene be used. The steric structure of polypropylene is not limited, and may be any of isotactic polypropylene, syndiotactic polypropylene, and atactic polypropylene.

Though the ratio of the polypropylene to the total polyolefin in the polyolefin resin composition is not particularly limited, from the viewpoint of achieving both heat resistance and suitable shutdown function, the content is preferably 1 to 35% by weight, more preferably 3 to 20% by weight, and further preferably 4 to 10% by weight. In this case, the polyolefin resin other than polypropylene is not limited, and examples thereof include homopolymers or copolymers of olefin hydrocarbons such as ethylene, 1-butene, 4-methyl-1-pentene, 1-hexene, and 1-octene. Specific examples thereof include polyethylene, polybutene, and ethylene-propylene random copolymers.

From the point of view of the shutdown characteristic in which the pores are closed by thermal melting, as the polyolefin resin other than polypropylene, it is preferable that a polyethylene such as low-density polyethylene, linear low-density polyethylene, medium density polyethylene, high density polyethylene, and ultra-high molecular weight polyethylene be used. Among these, from the viewpoint of strength, it is more preferable that a polyethylene having a density of 0.93 g/cm³ or more and 0.97 g/cm³ or less as measured in accordance with JIS K7112 be used.

The viscosity average molecular weight of the polyolefin resin constituting the polyolefin microporous membrane is not particularly limited, and is preferably 30,000 or more and 12 million or less, more preferably 50,000 or more and less than 2 million, further preferably 100,000 or more and less than 1,200,000, and most preferably 500,000 or more and less than 1 million. It is preferable that the viscosity average molecular weight be 30,000 or more because the melt tension during melt molding becomes large, resulting in suitable moldability, and the entanglement of polymers tends to result in high strength. Conversely, when the viscosity average molecular weight is 12 million or less, uniform melt-kneading becomes easy and sheet formability, and in particular, thickness stability, tends to be excellent, which is preferable. It is preferable that the viscosity average molecular weight be less than 1 million, since the pores tend to be easily blocked when the temperature rises and a suitable shutdown function can be obtained. For example, instead of using a polyolefin having a viscosity average molecular weight of less than 1 million, a mixture of a polyolefin having a viscosity average molecular weight of 2 million and a polyolefin having a viscosity average molecular weight of 270,000, the viscosity average molecular weight of which is less than 1 million, may be used.

The polyolefin microporous membrane of the present embodiment can contain arbitrary additives. Such additives are not particularly limited, and include, for example, polymers other than polyolefins; inorganic particles; phenol-based, phosphorus-based, sulfur-based antioxidants; metal soaps such as calcium stearate and zinc stearate; ultraviolet absorbers; light stabilizers; antistatic agents; antifogging agents; and colored pigments. The total content of these additives is preferably 20 parts by weight or less, more preferably 10 parts by weight or less, and further preferably 5 parts by weight or less, based on 100 parts by weight of the polyolefin resin composition.

### (Physical Properties of Polyolefin Microporous Membrane)

From the viewpoint of friction control as described above, the structure of the polyolefin microporous membrane is preferably optimized so that it has at least one of the following physical properties.

The puncture strength of the polyolefin microporous membrane (PO microporous membrane) when converted to a basis weight (g/m²) (hereinafter referred to as the basis weight equivalent puncture strength) is preferably 50 gf/(g/m²) or more or 60 gf/(g/m²) or more. A PO microporous membrane having a basis weight equivalent puncture strength of 50 gf/(g/m²) or more or 60 gf/(g/m²) or more is less likely to rupture in a safety test such as an impact test for an energy storage device. From the viewpoint of improving the safety of the energy storage device, such as impact resistance, while maintaining the strength of the PO microporous membrane, the basis weight equivalent puncture strength is more preferably 70 gf/(g/m²) or more, and further preferably 80 gf/(g/m²) or more. The basis weight equivalent puncture strength is not limited, and can be, for example, 200 gf/(g/m²) or less, 150 gf/(g/m²) or less, or 140 gf/(g/m²) or less. It should be noted that the CCS unit “gf” can be converted into the SI unit “N” by the formula: 1 gf≈0.0098 N.

Regarding the puncture strength when not converted into the basis weight of the PO microporous membrane (hereinafter simply referred to as puncture strength), the lower limit thereof is preferably 100 gf or more, more preferably 200 gf or more, and further preferably 300 gf or more. A puncture strength of 100 gf or more is preferable from the viewpoint of suppressing rupture of the PO microporous membrane in safety tests such as impact tests. The upper limit of the puncture strength of the PO microporous membrane is preferably 1000 gf or less, more preferably 800 gf or less, and further preferably 700 gf or less, from the viewpoint of stability during membrane formation. Any lower limit value can be used as long as it allows stable production in membrane formation and battery production. The upper limit value is set in balance with other characteristics. Though the puncture strength can be increased by increasing the shear force applied to the molded body during extrusion or by increasing the orientation of molecular chains due to stretching, as the strength increases, the thermal stability deteriorates due to the increase in residual stress, so it is controlled in accordance with the purpose.

Though the basis weight of the polyolefin microporous membrane of the present embodiment is not particularly limited, is preferably 1.8 g/m² or more, more preferably 2.8 g/m² or more, further preferably 3.0 g/m² or more, and particularly preferably 3.3 g/m² or more, and is preferably 7.0 g/m² or less, more preferably 6.9 g/m² or less, further preferably 6.7 g/m² or less, and particularly preferably 6.4 g/m² or less.

The porosity of the polyolefin microporous membrane of the present embodiment is not particularly limited, and is preferably 20% or more, more preferably 35% or more, further preferably 40% or more, and preferably 80% or less, more preferably 60% or less, and further preferably 55% or less. A porosity of 20% or more is preferable from the viewpoint of ensuring the permeability of the separator. Conversely, a porosity of 80% or less is preferable from the viewpoint of ensuring puncture strength. It should be noted that the porosity can be adjusted by changing the stretching ratio.

Further, from the viewpoint of controlling the coefficient of dynamic friction, it is preferable that the porosity of the polyolefin microporous membrane be within the above range. When there is a thermoplastic polymer layer on the surface on the porous substrate side, if the porosity of the polyolefin microporous membrane is high, when the thermoplastic polymer-containing layer is applied and dried, the coffee ring phenomenon is likely to occur, making it difficult for the thermoplastic polymer particles to pile up flat against the coated surface, and since there are fewer contact points between the thermoplastic polymer-containing layer on the porous substrate and stainless steel (SUS304), the coefficient of dynamic friction μ′_{α} between a surface of the separator on the porous substrate side and stainless steel (SUS304) tends to be small. Furthermore, when there is no thermoplastic polymer-containing layer on the surface on the porous substrate side, if the porosity of the polyolefin microporous membrane is high, since there are fewer contact points between the porous substrate and stainless steel (SUS304) than when the porosity is low, the coefficient of dynamic friction μ′_{α} between a surface of the separator on the porous substrate side and stainless steel (SUS304) tends to be small.

The thickness of the polyolefin microporous membrane of the present embodiment is not particularly limited, and is preferably 2 μm or more, more preferably 3 μm or more, further preferably 4 μm or more, particularly preferably 5 μm or more, and most preferably 6 μm or more, the upper limit thereof is preferably 30 μm or less, more preferably 20 μm or less, further preferably 16 μm or less, particularly preferably 10 μm or less, and most preferably 8 μm or less. It is preferable that the membrane thickness be 2 μm or more from the viewpoint of improving mechanical strength. Conversely, it is preferable that the membrane thickness be 30 μm or less because the volume occupied by the separator is reduced, which tends to be advantageous in terms of increasing the capacity of the battery.

The air permeability of the polyolefin microporous membrane of the present embodiment is not particularly limited, and is preferably 10 sec/100 cm³ or more, more preferably 20 sec/100 cm³ or more, further preferably 30 sec/100 cm³ or more, further preferably 50 sec/100 cm³ or more, particularly preferably 70 sec/100 cm³ or more, and most preferably 80 sec/100 cm³ or more, and is preferably 200 sec/100 cm³ or less, more preferably 180 sec/100 cm³ or less, further preferably 140 sec/100 cm³ or less, and particularly preferably 120 sec/100 cm³ or less. It is preferable that the air permeability be 10 sec/100 cm³ or more from the viewpoint of suppressing self-discharge of the energy storage device. Conversely, it is preferable that the air permeability be 200 sec/100 cm³ or less from the viewpoint of obtaining suitable charge/discharge characteristics. It should be noted that the above air permeability can be adjusted by changing the stretching temperature, stretching ratio, etc.

The average pore diameter of the polyolefin microporous membrane of the present embodiment is preferably 0.15 μm or less, more preferably 0.1 μm or less, and is preferably 0.01 μm or more as a lower limit. Setting the average pore diameter to 0.15 μm or less is suitable during use as a separator for an energy storage device, from the viewpoint of suppressing self-discharge of the energy storage device and suppressing a decrease in capacity. The average pore diameter can be adjusted by changing the stretching ratio when producing the polyolefin microporous membrane.

The short-circuit temperature, which is an index of heat resistance, of the polyolefin microporous membrane of the present embodiment is preferably 140° C. or higher, more preferably 150° C. or higher, and further preferably 160° C. or higher. In case of use as a separator for an energy storage device, it is preferable to set the short-circuit temperature to 140° C. or higher from the viewpoint of safety of the energy storage device.

The viscosity average molecular weight of the polyolefin microporous membrane of the present embodiment is not particularly limited, and is preferably 100,000 or more and 5,000,000 or less, more preferably 300,000 or more 1,500,000 or less, and further preferably 500,000 or more and 1,000,000 or less. A viscosity average molecular weight of 100,000 or more and 5,000,000 or less is preferable from the viewpoints of puncture strength, permeability, heat shrinkage, and shutdown function of the polyolefin microporous membrane.

### (Method for Production of Polyolefin Microporous Membrane)

The method for the production of the polyolefin microporous membrane of the present embodiment is not particularly limited, and any known manufacturing method can be employed. Examples thereof include a method in which a polyolefin resin composition and a plasticizer are melt-kneaded, formed into a sheet-like shape, optionally stretched, and then made porous by extracting the plasticizer; a method of melt-kneading a polyolefin resin composition and extruding it at a high draw ratio, and then exfoliating the polyolefin crystal interface by heat treatment and stretching to make it porous; a method in which a polyolefin resin composition and an inorganic filler are melt-kneaded, formed into a sheet, and then made porous by peeling off the interface between the polyolefin and the inorganic filler by stretching; and a method in which after dissolving the polyolefin resin composition, it is immersed in a poor solvent for polyolefin to coagulate the polyolefin and simultaneously remove the solvent to make it porous. Among these, it is preferable to select a method that optimizes the structure of the resulting polyolefin microporous membrane as the porous substrate, for example, a method that includes a stretching step, from the viewpoint of friction control and pin removal properties as described above. Hereinafter, as an example of a method for the production of the microporous membrane, a method in which a polyolefin resin composition and a plasticizer are melt-kneaded, molded into a sheet-like shape, and then the plasticizer is extracted will be described.

First, a polyolefin resin composition and a plasticizer are melt-kneaded. Examples of the melt-kneading method include a method in which a polyolefin resin and other additives as necessary are introduced into a resin kneading device such as an extruder, a kneader, a Labo Plast mill, a kneading roller, or a Banbury mixer, and while heating and melting the resin components, a plasticizer is introduced at an arbitrary ratio and kneaded. At this time, it is preferable that the polyolefin resin, other additives, and plasticizer be pre-kneaded at a predetermined ratio using a Henschel mixer or the like before being introduced into the resin kneading device. More preferably, only a part of the plasticizer is added during preliminary kneading, and the remaining plasticizer is kneaded while being side-fed to the resin kneading device. As a result, the dispersibility of the plasticizer is improved, and when the sheet-shaped molded body of the melt-kneaded mixture of the resin composition and plasticizer is stretched in a subsequent step, it can be stretched at a high magnification without membrane rupture.

As the plasticizer, a nonvolatile solvent capable of forming a homogeneous solution at a temperature equal to or higher than the melting point of the polyolefin can be used. Specific examples of such nonvolatile solvents include hydrocarbons such as liquid paraffin and paraffin wax; esters such as dioctyl phthalate and dibutyl phthalate; and higher alcohols such as oleyl alcohol and stearyl alcohol. Among these, liquid paraffin is preferable because it has high compatibility with polyethylene and polypropylene, and interfacial peeling between the polyolefin resin composition and the plasticizer is unlikely to occur even when the melt-kneaded material is stretched, facilitating uniform stretching.

The ratio of the polyolefin resin composition to the plasticizer is not particularly limited as long as they can be uniformly melt-kneaded and molded into a sheet. For example, the weight fraction of the plasticizer in a composition consisting of a polyolefin resin composition and a plasticizer is preferably 30 to 80% by weight, more preferably 40 to 70% by weight. When the weight fraction of the plasticizer is 80% by weight or less, melt tension during melt molding is unlikely to be insufficient, whereby moldability tends to be improved. Conversely, when the weight fraction is 30% by weight or more, even if the mixture of the polyolefin resin composition and plasticizer is stretched at a high magnification, the polyolefin chains will not be cut, whereby a uniform and fine pore structure will be formed, and the strength can easily be improved.

Next, the melt-kneaded product is formed into a sheet-like shape. Examples of the method for producing a sheet-like molded body include a method in which a melt-kneaded product is extruded into a sheet-like form through a T-die or the like, and cooled to a temperature sufficiently lower than the crystallization temperature of the resin component by contacting with a heat conductor to solidify the material. As the heat conductor used for cooling and solidification, metal, water, air, or the plasticizer itself can be used, and metal rollers are preferable because of their high heat conduction efficiency. At this time, it is more preferable to interpose the sheet between the metal rollers when it is brought into contact with the metal rollers, since this further increases the efficiency of heat conduction, increases the membrane strength by orienting the sheet, and improves the surface smoothness of the sheet. The die lip interval when extruding into a sheet-like shape from a T-die is preferably 400 μm or more and 3000 μm or less, and more preferably 500 μm or more and 2500 μm or less. When the die lip interval is 400 μm or more, tip adhesion and the like are reduced, and there is less impact on membrane quality such as streaks and defects, and membrane rupture and the like tend to be prevented in the subsequent stretching step. Conversely, when the die lip interval is 3000 μm or less, the cooling rate is fast and uneven cooling can be prevented, whereby the thickness stability of the sheet tends to be maintained.

It is preferable to stretch the sheet-like molded body obtained in this manner. As the stretching treatment, either uniaxial stretching or biaxial stretching can suitably be used, but biaxial stretching is preferable from the viewpoint of strength of the resulting porous membrane. When a sheet-like molded body is stretched biaxially at a high magnification, the molecules are oriented in the planar direction, and the ultimately-obtained porous membrane becomes unlikely to tear and has high puncture strength. Examples of the stretching method include simultaneous biaxial stretching, sequential biaxial stretching, multistage stretching, and multiple stretching, and simultaneous biaxial stretching is preferable from the viewpoint of improving puncture strength, uniformity of stretching, and shutdown characteristics.

It should be noted that as used herein, simultaneous biaxial stretching refers to a stretching method in which stretching in the MD direction and stretching in the TD direction are performed simultaneously, though the stretching ratio in each direction may be different. Sequential biaxial stretching refers to a stretching method in which MD direction or TD direction stretching is performed independently, and when stretching is performed in MD direction or TD direction, the other direction is unrestricted or fixed at a constant length.

The stretching ratio is preferably in the range of 20-fold or more and 100-fold or less in area magnification, and more preferably in the range of 25-fold or more and 50-fold or less. The stretching ratio in each axial direction is preferably in the range of 4-fold or more and 10-fold or less in the MD direction and 4-fold or more and 10-fold or less in the TD direction, and more preferably in the range of 5-fold or more and 8-fold or less in the MD direction and 5-fold or more and 8-fold or less in the TD direction. If the total area magnification is 20-fold or more, sufficient strength will tend to be imparted to the resulting porous membrane, and conversely, if the total area magnification is 100-fold or less, membrane rupture during the stretching step will be prevented, whereby high productivity can be obtained.

Alternatively, the sheet-like molded body may be rolled. Rolling can be carried out by, for example, a pressing method using a double belt press machine or the like. Rolling can increase the orientation, in particular in the surface layer portion. The rolling surface magnification is preferably greater than 1-fold and 3-fold or less, and more preferably greater than 1-fold and 2-fold or less. When the rolling magnification is greater than 1, the planar orientation tends to increase and the strength of the ultimately obtained porous membrane tends to increase. Conversely, it is preferable that the rolling magnification be 3-fold or less because the difference in orientation between a surface layer portion and the center interior is small, and a uniform porous structure can be formed in the thickness direction of the membrane.

Next, the plasticizer is removed from the sheet-like molded body to form a microporous membrane. Examples of the method for removing the plasticizer include a method of immersing the sheet-like molded body in an extraction solvent to extract the plasticizer, and thoroughly drying the molded body. The method for extracting the plasticizer may be either a batch method or a continuous method. In order to suppress shrinkage of the microporous membrane, it is preferable to restrain the ends of the sheet-like molded body during the series of steps of immersion and drying. Further, the amount of plasticizer remaining in the microporous membrane is preferably less than 1% by weight.

As the extraction solvent, it is preferable to use one that is a poor solvent for the polyolefin resin composition, a good solvent for the plasticizer, and has a boiling point lower than the melting point of the polyolefin resin. Examples of such extraction solvents include hydrocarbons such as n-hexane and cyclohexane; halogenated hydrocarbons such as methylene chloride and 1,1,1-trichloroethane; non-chlorine halogenated solvents such as hydrofluoroethers and hydrofluorocarbons; alcohols such as ethanol and isopropanol; ethers such as diethyl ether and tetrahydrofuran; and ketones such as acetone and methyl ethyl ketone. It should be noted that these extraction solvents may be recovered and reused by operations such as distillation.

In order to suppress shrinkage of the microporous membrane, heat treatment such as heat setting or thermal relaxation may be performed after the stretching step or after the formation of the microporous membrane. Further, from the viewpoint of friction control and the pin removal properties described above, the microporous membrane may be subjected to post-treatment to optimize the structure of the microporous membrane. For example, the microporous membrane may be subjected to post-treatments such as hydrophilic treatment with a surfactant and crosslinking treatment with ionizing radiation, and the tensile strength of the microporous membrane may be adjusted as appropriate to bring it into the optimum range.

### [Thermoplastic Polymer-Containing Layer]

The thermoplastic polymer-containing layer according to the present embodiment contains a thermoplastic polymer and is arranged on the surface of the porous substrate and on the surface of the inorganic filler-containing layer arranged on one face of the porous substrate. From the viewpoint of improving the pin removal properties and from the viewpoint of friction control as described above, the thermoplastic polymer-containing layer is arranged on the surface of the porous substrate and on the surface of the inorganic filler-containing layer arranged on one face of the porous substrate, and it is preferable that the thermoplastic polymer-containing layer be arranged so that at least a portion of the thermoplastic polymer-containing layer is exposed or covered on both sides of the separator. The thermoplastic polymer-containing layer according to the present embodiment may not be arranged on the surface of the porous substrate, and may be arranged on only the surface of the inorganic filler-containing layer arranged on one face of the porous substrate. In this case, it is preferable that at least a portion of the thermoplastic polymer-containing layer arranged on the surface of the inorganic filler-containing layer be exposed or covered.

In the separator according to the present embodiment, when thermoplastic polymer-containing layers are arranged on both sides of the separator, the thermoplastic polymer-containing layers arranged on both sides may be the same or different based on the porous substrate. In view of environmental considerations, economy, and productivity, it is preferable that both thermoplastic polymer-containing layers have the same configuration.

### (Thermoplastic Polymer)

The thermoplastic polymer according to the present embodiment is not particularly limited, and examples thereof include polyolefin resins such as polyethylene, polypropylene, and α-polyolefin; fluorine-containing resins such as polyvinylidene fluoride and polytetrafluoroethylene, and copolymers containing these; diene-based polymers containing conjugated dienes such as butadiene and isoprene as monomer units, or copolymers containing these and hydrides thereof; acrylic polymers containing acrylic esters, and methacrylic esters as monomer units, or copolymers containing these, and hydrides thereof; rubbers such as ethylene propylene rubber, polyvinyl alcohol, polyvinyl acetate; cellulose derivatives such as ethylcellulose, methylcellulose, hydroxyethylcellulose, and carboxymethylcellulose; resins having a melting point and/or glass transition temperature of 180° C. or higher, such as polyphenylene ether, polysulfone, polyethersulfone, polyphenylene sulfide, polyetherimide, polyamideimide, polyamide, and polyester, and mixtures thereof. It should be noted that monomers having a hydroxyl group, a sulfonic acid group, a carboxyl group, an amide group, or a cyano group can also be used as the monomer used when synthesizing the thermoplastic polymer.

### (Dynamic Viscoelasticity of Thermoplastic Polymer)

It is preferable that the thermoplastic polymer have a suitable balance between viscosity and elasticity. Specifically, from the viewpoint of improving pin removal properties and friction control as described above, the loss tangent (tan δ value) of the thermoplastic polymer at 30° C. when dynamic viscoelasticity measurement of the thermoplastic polymer is performed at 1 Hz is preferably 0.01 or more and 0.05 or less, and more preferably 0.02 or more and 0.04 or less. When the thermoplastic polymer has a large loss tangent (tan δ value) at 30° C. when dynamic viscoelasticity measurement of the thermoplastic polymer is performed at 1 Hz, the coefficient of dynamic friction μ′_{α} between a surface of the separator on the porous substrate side and stainless steel (SUS304) and the coefficient of dynamic friction μ′_{β} between a surface of the separator on the inorganic filler-containing layer side and a lithium metal oxide-containing face of a predetermined positive electrode f tend to be small.

The maximum value of the loss tangent (tan δ value) when dynamic viscoelasticity measurement of the thermoplastic polymer is performed at 1 Hz is preferably at 70° C. or higher, more preferably within the range of 80° C. to 120° C., and further preferably within the range of 90° C. to 110° C. If the maximum value of tan δ of the thermoplastic polymer in dynamic viscoelasticity measurement performed at 1 Hz is at 70° C. or higher, since the physical properties of the thermoplastic polymer do not change significantly even at relatively high temperatures, the safety of the energy storage device including the separator according to the present embodiment tends to be improved.

The dynamic viscoelasticity of the thermoplastic polymer can be appropriately adjusted by, for example, the arrangement of the thermoplastic polymer-containing layer on the surface of the porous substrate or on the inorganic filler-containing layer, or the selection of the polymer raw materials and the design of the thermoplastic resin in the production process of the separator.

Among the thermoplastic polymers listed above, diene polymers, acrylic polymers, and fluorine polymers are preferable because they have excellent adhesion to electrode active materials, strength, and flexibility.

### (Diene Polymer)

The diene polymer is not particularly limited, and is, for example, a polymer containing a monomer unit formed by polymerizing a conjugated diene having two conjugated double bonds, such as butadiene and isoprene. Examples of conjugated diene monomers include, but are not particularly limited to, 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, and 3-butyl-1,3-octadiene. These may be polymerized alone or may be copolymerized.

The proportion of monomer units formed by polymerizing a conjugated diene in the diene polymer is not particularly limited, and is, for example, 40% by weight or more, preferably 50% by weight or more, and more preferably 60% by weight or more of the total of the diene polymer.

Examples of the diene-based polymer include, but are not particularly limited to, homopolymers of conjugated dienes such as polybutadiene and polyisoprene, and copolymers of conjugated dienes and monomers copolymerizable with them. The copolymerizable monomers are not particularly limited, and examples thereof include (meth)acrylate monomers described below and monomers described below (hereinafter also referred to as “other monomers”).

Examples of the “other monomers” include, but are not limited to, α,β-unsaturated nitrile compounds such as acrylonitrile and methacrylonitrile; unsaturated carboxylic acids such as acrylic acid, methacrylic acid, itaconic acid, and fumaric acid; styrenic monomers such as styrene, chlorostyrene, vinyltoluene, t-butylstyrene, vinylbenzoic acid, methyl vinylbenzoate, vinylnaphthalene, chloromethylstyrene, hydroxymethylstyrene, and α-methylstyrene, and divinylbenzene; olefins such as ethylene and propylene; halogen atom-containing monomers such as vinyl chloride and vinylidene chloride; vinyl esters such as vinyl acetate, vinyl propionate, vinyl butyrate, and vinyl benzoate; vinyl ethers such as methyl vinyl ether, ethyl vinyl ether, and butyl vinyl ether; vinyl ketones such as methyl vinyl ketone, ethyl vinyl ketone, butyl vinyl ketone, hexyl vinyl ketone, and isopropenyl vinyl ketone; heterocycle-containing vinyl compounds such as N-vinylpyrrolidone, vinylpyridine, and vinylimidazole; acrylic ester and/or methacrylic ester compounds such as methyl acrylate and methyl methacrylate; hydroxyalkyl group-containing compounds such as β-hydroxyethyl acrylate and β-hydroxyethyl methacrylate; and amide monomers such as acrylamide, N-methylolacrylamide, and acrylamide-2-methylpropanesulfonic acid, and these may be used alone or in combination of two or more thereof.

### (Acrylic Polymer)

The acrylic polymer is not particularly limited, and is preferably a polymer containing monomer units obtained by polymerizing a (meth)acrylate monomer.

When the thermoplastic polymer-containing layer contains an acrylic polymer as the thermoplastic polymer, the acrylic polymer preferably contains a copolymer containing a monomer unit of a (meth)acrylic acid ester monomer. When the thermoplastic polymer of the thermoplastic polymer-containing layer contains a copolymer containing a monomer unit of a (meth)acrylic acid ester monomer, it is preferable from the viewpoints of improving adhesive strength when the separator has a low basis weight, improving the pin removal properties, and controlling friction as described above.

In the present description, “(meth)acrylic acid” indicates “acrylic acid or methacrylic acid”, and “(meth)acrylate” indicates “acrylate or methacrylate”.

Examples of (meth)acrylate monomers include, but are not particularly limited to, alkyl (meth)acrylates such as methyl (meth)acrylate, ethyl (meth)acrylate, n-propyl (meth)acrylate, isopropyl (meth)acrylate, n-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, lauryl (meth)acrylate, n-tetradecyl (meth)acrylate, and stearyl (meth)acrylate; hydroxy group-containing (meth)acrylates such as hydroxyethyl (meth)acrylate, hydroxypropyl (meth)acrylate, and hydroxybutyl (meth)acrylate; amino group-containing (meth)acrylates such as aminoethyl (meth)acrylate; and epoxy group-containing (meth)acrylates such as glycidyl (meth)acrylate (GMA).

The proportion of monomer units obtained by polymerizing (meth)acrylate monomers is not particularly limited, and is, for example, 40% by weight or more, preferably 50% by weight or more, and more preferably 60% by weight or more of the total of the acrylic polymer. Examples of the acrylic polymer include homopolymers of (meth)acrylate monomers and copolymers of the (meth)acrylate monomers with monomers copolymerizable therewith. Examples of copolymerizable monomers include the “other monomers” listed in the section of diene polymers, and these may be used alone or in combination of two or more.

### (Fluoropolymer)

Examples of fluoropolymers include, but are not particularly limited to, homopolymers of vinylidene fluoride and copolymers of vinylidene fluoride and copolymerizable monomers. Fluoropolymers are preferable from the viewpoint of electrochemical stability.

The proportion of monomer units formed by polymerizing vinylidene fluoride is not particularly limited, and is, for example, 40% by weight or more, preferably 50% by weight or more, and more preferably 60% by weight or more. Monomers which are copolymerizable with vinylidene fluoride are not particularly limited, and examples thereof include fluorine-containing ethylenically unsaturated compounds such as vinyl fluoride, tetrafluoroethylene, trifluorochloroethylene, hexafluoropropylene, hexafluoroisobutylene, perfluoroacrylic acid, perfluoromethacrylic acid, and fluoroalkyl esters of acrylic acid or methacrylic acid; fluorine-free ethylenically unsaturated compounds such as cyclohexyl vinyl ether and hydroxyethyl vinyl ether; and fluorine-free diene compounds such as butadiene, isoprene, and chloroprene.

Among these fluoropolymers, vinylidene fluoride homopolymers, vinylidene fluoride/tetrafluoroethylene copolymers, and vinylidene fluoride/tetrafluoroethylene/hexafluoropropylene copolymers are preferable. Particularly preferable fluoropolymers include vinylidene fluoride/tetrafluoroethylene/hexafluoropropylene copolymers, and the monomer composition thereof is conventionally 30 to 90% by weight of vinylidene fluoride, 50 to 9% by weight of tetrafluoroethylene, or 20 to 1% by weight of the hexafluoropropylene. These fluororesin particles may be used alone or in combination of two or more thereof.

As the monomer used when synthesizing the above thermoplastic polymer, a monomer having a hydroxyl group, a carboxyl group, an amino group, a sulfonic acid group, an amide group, or a cyano group can also be used.

The monomer having a hydroxyl group is not particularly limited, and examples thereof include vinyl monomers such as pentenol.

The monomer having a carboxyl group is not particularly limited, and examples thereof include unsaturated carboxylic acids having an ethylenic double bond such as (meth)acrylic acid and itaconic acid, and vinyl monomers such as pentenoic acid.

The monomer having an amino group is not particularly limited, and examples thereof include 2-aminoethyl methacrylate.

The monomer having a sulfonic acid group is not particularly limited, and examples thereof include vinylsulfonic acid, methylvinylsulfonic acid, (meth)alisulfonic acid, styrenesulfonic acid, ethyl (meth)acrylate-2-sulfonate, 2-acrylamido-2-methylpropanesulfonic acid, and 3-allyloxy-2-hydroxypropanesulfonic acid

The monomer having an amide group is not particularly limited, and examples thereof include acrylamide (AM), methacrylamide, N-methylolacrylamide, and N-methylolmethacrylamide.

The monomer having a cyano group is not particularly limited, and examples thereof include acrylonitrile (AN), methacrylonitrile, α-chloroacrylonitrile, and α-cyanoethyl acrylate.

The thermoplastic polymer used in the present embodiment may be used alone or in a mixture of two or more types thereof, but preferably contains two or more types of polymers. The thermoplastic polymer may be used together with a solvent, and the solvent may be one that can uniformly and stably disperse the thermoplastic polymer, such as N-methylpyrrolidone, N,N-dimethylformamide, N,N-dimethylacetamide, water, ethanol, toluene, hot xylene, methylene chloride, hexane, and among these, an aqueous solvent is preferable. The thermoplastic polymer can also be used in latex form.

### (Glass Transition Point of Thermoplastic Polymer)

From the viewpoint of friction control as described above, the viewpoint of adhesion to the substrate and prevention of blocking, and the viewpoint of the balance between adhesive strength and flaking resistance, the thermoplastic polymer constituting the thermoplastic polymer-containing layer preferably has thermal characteristics wherein the thermoplastic polymer has at least two glass transition temperatures, at least one of the glass transition temperatures is present in a region of lower than 20° C., and at least one of the glass transition temperatures is present in a region of 30° C. or higher.

The glass transition temperature is determined from a DSC curve obtained by differential scanning calorimetry (DSC). It should be noted that in the present description, the glass transition temperature is sometimes expressed as Tg.

Specifically, the glass transition temperature is determined by the intersection of a straight line extending from the low-temperature side baseline of the DSC curve toward the high-temperature side and a tangent at the inflection point of the step-like change portion of the glass transition. For more details, reference may be made to the methods described in the Examples.

“Glass transition” refers to a change in heat amount occurring on the endothermic side due to a change in the state of a test sample polymer in DSC. Such a change in heat amount is observed in a DSC curve as a step-like change shape or a shape that is a combination of a step-like change and a peak.

“Step-like change” refers to a portion of a DSC curve where the curve leaves the previous baseline and transitions to a new baseline. It should be noted that shapes that are a combination of peaks and step-like changes are also encompassed thereby.

“Inflection point” refers to a point where the gradient of the DSC curve of the step-like change portion is maximum. It can also be expressed as a point at which an upwardly convex curve changes to a downwardly convex curve in a step-like change portion.

“Peak” refers to a portion of a DSC curve where the curve departs from the baseline and returns to the baseline again.

“Baseline” refers to a DSC curve in a temperature range where no transition or reaction occurs in the test sample.

In the present embodiment, at least one of the glass transition temperatures of the thermoplastic polymer used is present in a region of lower than 20° C., whereby control of the coefficient of dynamic friction with SUS304 or with the lithium metal oxide-containing face of a predetermined positive electrode is excellent, adhesion to the porous substrate or inorganic filler-containing layer is excellent, and blocking is suppressed, resulting in an effect on excellent adhesion between the separator and the electrode. From the viewpoint of handling properties and anti-blocking properties, the glass transition temperature is preferably −100° C. or higher, more preferably −50° C. or higher, further preferably −40° C. or higher, and particularly preferably −6° C. or higher, and from the viewpoint of controlling the coefficient of dynamic friction and adhesion to the porous substrate or inorganic filler-containing layer, the temperature is preferably lower than 20° C., more preferably 10° C. or lower, or particularly preferably 0° C. or lower.

In the present embodiment, since at least one of the glass transition temperatures of the thermoplastic polymer used is present in a region of 30° C. or higher, control of the coefficient of dynamic friction with SUS304 or control of the coefficient of dynamic friction with a lithium metal oxide-containing face of a predetermined positive electrode f is excellent, and adhesion between the separator and electrode and handling properties are excellent. The glass transition temperature is preferably 30° C. or higher, more preferably 40° C. or higher, further preferably 70° C. or higher, and particularly preferably 85° C. or higher, from the viewpoint of controlling the coefficient of dynamic friction, handling properties, and blocking resistance, and from the viewpoint of adhesive strength, it is preferably 150° C. or lower, more preferably 130° C. or lower, and particularly preferably 120° C. or lower.

A thermoplastic polymer having two glass transition temperatures can be achieved, for example, by a method of blending two or more types of thermoplastic polymers or by structural design of the thermoplastic resin, but is not limited to this method.

In particular, in the case of polymer blends, it is possible to control the glass transition temperature of the entire thermoplastic polymer by combining polymers with high and low glass transition temperatures. Additionally, multiple functions can be imparted to the entire thermoplastic polymer. For example, in the case of blends, it is possible to achieve both improved stickiness resistance and friction control by blending two or more types of polymers, one having a glass transition temperature present in the region of 30° C. or higher and the other having a glass transition temperature present in the region of less than 20° C. When blending, the mixing ratio of the polymer having a glass transition temperature of 30° C. or higher and the polymer having a glass transition temperature of lower than 20° C. is preferably in the range of 0.1:99.9 to 9 to 9.99:0.1, more preferably 5:95 to 95:5, further preferably 50:50 to 95:5, and even further preferably 60:40 to 90:10. Viscoelasticity can also be controlled by combining a polymer having a high viscosity and a polymer having high elasticity.

In the present embodiment, the glass transition temperature, i.e., Tg, of the thermoplastic polymer can be adjusted as appropriate by, for example, changing the monomer components used to produce the thermoplastic polymer and the input ratio of each monomer. Specifically, for each monomer used in the production of thermoplastic polymers, it can be roughly estimated from the Tg of the homopolymer (described in, for example, the “Polymer Handbook” (A Wiley-Interscience Publication)) and the monomer blending ratio, which is generally indicated for each monomer. For example, copolymers containing a high proportion of monomers such as styrene, methyl methacrylate, and acrylonitrile, which impart a polymer with a Tg of approximately 100° C., have a high Tg, and for example, copolymers containing a high proportion of monomers such as butadiene, which imparts a polymer with a Tg of approximately −80° C., and n-butyl acrylate and 2-ethylhexyl acrylate, which impart a polymer with a Tg of approximately −50° C., have a low Tg.

The Tg of the polymer can be roughly estimated from the FOX formula (formula (1) below). It should be noted that the glass transition point of the thermoplastic polymer of the present embodiment is determined by the method using the DSC described above.

$$1 / Tg = {W}_{1} / {Tg}_{1} + {W}_{2} / {Tg}_{2} + … + {W}_{i} / {Tg}_{i} + … {W}_{n} / {Tg}_{n} \qquad ( 1 )$$

where Tg (K) represents the Tg of the copolymer, Tgᵢ (K) represents the Tg of the homopolymer of each monomer i, and Wᵢ represents the mass fraction of each monomer.

The glass transition temperature of the thermoplastic polymer is determined by the following method.

An appropriate amount of the thermoplastic polymer coating liquid is placed on an aluminum plate and dried in a hot air dryer at 130° C. for 30 minutes. Approximately 5 mg of the dried membrane is packed into an aluminum container for measurement, and a DSC curve and a DDSC curve are obtained in a nitrogen atmosphere using a DSC measuring device (DSC Q2000, manufactured by TA Instruments). The measurement conditions are as follows.

### (First Stage Temperature Increase Program)

Starting at 40° C., the temperature is increased at a rate of 50° C. per minute. After reaching 200° C., it is maintained for 5 minutes.

### (Second Stage Temperature Reduction Program)

The temperature is reduced from 200° C. at a rate of 20° C. per minute. After reaching −50° C., it is maintained for 5 minutes.

### (Third Stage Temperature Increase Program)

The temperature is increased from −50° C. to 200° C. at a rate of 20° C. per minute. DSC and DDSC data are acquired during this third stage of temperature rise.

According to the method described in JIS-K7121, the intersection of the baseline (the straight line given by extending the baseline in the obtained DSC curve toward the high temperature side) and the tangent at the inflection point (the point where the upwardly convex curve changes to a downwardly convex curve) is the glass transition temperature (Tg).

### (Structure of Thermoplastic Polymer-Containing Layer)

In the thermoplastic polymer-containing layer, it is preferable that a thermoplastic resin having a glass transition temperature of 30° C. or higher and 120° C. or lower be present on the outermost surface side of the separator for an energy storage device, and a thermoplastic resin having a glass transition temperature of lower than 20° C. be present at the interface between the polyolefin microporous membrane and the thermoplastic polymer-containing layer. It should be noted that the “outermost surface” refers to the surface of the thermoplastic polymer-containing layer that comes into contact with the electrode when the separator for an energy storage device and the electrode are stacked. Furthermore, the term “interface” refers to the surface of the thermoplastic polymer-containing layer that is in contact with the polyolefin microporous membrane.

In the thermoplastic polymer-containing layer, since a thermoplastic polymer having a glass transition temperature of 30° C. or higher and 120° C. or lower is present on the outermost surface of the separator for an energy storage device, the adhesion to the microporous membrane is excellent, and as a result, the adhesion between the separator and the electrode tends to be excellent. Since a thermoplastic polymer having a glass transition temperature of lower than 20° C. is present at the interface between the polyolefin microporous membrane and the thermoplastic polymer-containing layer, the adhesion between the separator and the electrode and handling properties tend to be excellent. When the separator has such a thermoplastic polymer-containing layer, the adhesion between the separator and the electrode and handling properties tend to be further improved.

The structure as described above can be achieved by (a) the thermoplastic polymer being composed of a particulate thermoplastic polymer and a binder polymer that adheres the particulate thermoplastic polymer to the polyolefin microporous membrane with the particulate thermoplastic polymer exposed to the surface, and in which the glass transition temperature of the particulate thermoplastic polymer is in the range of 30° C. or higher and 120° C. or lower, and a thermoplastic polymer having a glass transition temperature of lower than 20° C. is present at the interface between the polyolefin microporous membrane and the thermoplastic polymer-containing layer, and (b) the thermoplastic polymer having a stacked structure, and the glass transition temperature of the thermoplastic polymer in the outermost layer when used in a separator is in the range of 30° C. or higher and 120° C. or lower, and a thermoplastic polymer having a glass transition temperature of lower than 20° C. is present at the interface between the polyolefin microporous membrane and the thermoplastic polymer-containing layer. It should be noted that (b) the thermoplastic polymer may have a stacked structure of polymers having different Tg.

### (Average Particle Diameter of Thermoplastic Polymer)

The configuration of the thermoplastic polymer of the present embodiment is not particularly limited, but may be configured, for example, in a granular form. Having such a structure tends to improve the adhesion between the separator and the electrode and the handling properties of the separator. Particulate as used herein refers to a state in which individual thermoplastic polymers have a contour as measured by a scanning electron microscope (SEM), and it may be an elongated shape, a spherical shape, or a polygonal shape.

The particle size distribution and median diameter of the particulate thermoplastic polymer can be measured using a laser particle size distribution analyzer (Microtrac MT3300EX manufactured by Nikkiso Co., Ltd.). If desired, the particle size distribution of the particulate thermoplastic polymer can be adjusted using the particle size distribution of the water or binder polymer as a baseline. The particle size at which the cumulative frequency is 50% is defined as volume average particle diameter D₅₀, and the D₅₀ of the particulate thermoplastic polymer is defined as D_{P}.

From the viewpoint of friction control as described above, improvement of the pin removal properties, and adhesive strength with the separator electrode, the D_{P}, the volume average particle diameter of the granular thermoplastic polymer is preferably 100 nm or more and 800 nm or less, more preferably 200 nm or more and 700 nm or less, further preferably 300 nm or more and 650 nm or less, particularly preferably 400 nm or more and 600 nm or less, and most preferably 500 nm or more and 590 nm or less. The average particle diameter D_{P} of the particulate thermoplastic polymer can be adjusted in accordance with, for example, the design of the thermoplastic resin.

### (Dot-Like Pattern)

The thermoplastic polymer-containing layer is preferably arranged in a dot-like pattern on the surface of the porous substrate and the surface of the inorganic filler-containing layer from the viewpoint of friction control as described above. The dot-like shape indicates that on the polyolefin microporous membrane, there are portions which contain the thermoplastic polymer and portions which do not contain the thermoplastic polymer, and the portions containing the thermoplastic polymer are present in island-like shapes. It should be noted that in the thermoplastic resin layer, the portions containing the thermoplastic polymer may be independent.

From the viewpoints of friction control as described above, reducing the resistance of the battery, facilitating gas escape, increasing safety by reducing the likelihood of trapping heat, and adhesion between the separator and the electrode, the diameter of the dots of the thermoplastic polymer-containing layer is preferably 50 μm or more and 1000 μm or less, more preferably 100 μm or more and 500 μm or less, particularly preferably 150 μm or more and 300 μm or less, and most preferably 200 μm or more and 300 μm or less.

The dot-like pattern of the thermoplastic resin layer specified above can be achieved by, for example, in the separator production process, optimizing the coating liquid containing the thermoplastic polymer, adjusting the polymer concentration or coating amount of the coating liquid, the coating method or coating conditions, and printing plate design.

(Degree of Swelling of Thermoplastic Polymer with Respect to Electrolyte Solution)

The thermoplastic polymer of the present embodiment preferably has swelling properties with respect to the electrolyte from the viewpoint of battery characteristics such as cycle characteristics and from the viewpoint of electrode adhesion in the presence of the electrolyte solution (wet). More specifically, since it increases ion permeability, increases bulk strength when in close contact with the electrode surface, and improves adhesion, the degree of swelling of the thermoplastic polymer with respect to the electrolyte solution is preferably 1.5 to 20-fold, more preferably 2 to 15-fold, further preferably 6 to 12-fold, and particularly preferably 7 to 10-fold. The degree of swelling of the thermoplastic polymer with respect to the electrolyte solution in the present embodiment can be adjusted by, for example, changing the monomer components to be polymerized and the input ratio of each monomer.

### (Measurement of Degree of Swelling of Thermoplastic Polymer)

A dried uniform diffusion layer material can be obtained by vacuum-drying the material used for the thermoplastic polymer-containing layer for 12 hours at a temperature below its melting point to completely remove the solvent. Approximately 0.5 g of the obtained dried product was weighed and defined as the weight before immersion (WA). This dried product was placed in a 50 mL vial together with 15 g of an electrolyte solution of ethylene carbonate (EC):ethyl methyl carbonate (EMC)=1:2 (volume ratio) containing 1 mol/L LiPF₆ and 1 wt % vinylene carbonate at 25° C., immersed for 72 hours, and thereafter, the sample was removed, and the mass was measured immediately after wiping it with a towel paper, and the mass thereof was determined as the weight after immersion (WB).

The electrolyte-solution swelling degree of the thermoplastic polymer-containing layer is calculated using the following formula.

Degree of swelling (fold)=WB/WA

It should be noted that in the above formula, if the material of the uniform diffusion layer neither swelled nor dissolved in the electrolyte solution, the degree of swelling was 1-fold.

### (Basis Weight of Thermoplastic Polymer-Containing Layer Per Face)

In the separator according to the present embodiment, from the viewpoint of achieving both adhesive strength with the electrode and ion permeability, the basis weight of the thermoplastic polymer-containing layer per face is preferably 0.03 g/m² or more and 0.50 g/m² or less, more preferably 0.04 g/m² or more and 0.30 g/m² or less, and most preferably 0.06 g/m² or more and 0.20 g/m² or less. The basis weight of the thermoplastic polymer-containing layer can be adjusted by changing the polymer concentration of the coating liquid and the coating amount of the polymer solution. A range exceeding 0.06 g/m² is preferable from the viewpoint of suppressing deformation of the cell shape due to expansion and contraction of the electrode and improving the cycle characteristics of the battery within a range that does not inhibit the effects of the present embodiment.

### (Coverage Area Ratio of Thermoplastic Polymer-Containing Layer Relative to Substrate or Inorganic Filler-Containing Layer Surface)

In the present embodiment, from the viewpoint of friction control as described above, the viewpoint of improving pin removal properties, and the viewpoint of reducing battery resistance while maintaining adhesive strength with the separator electrode, the total coverage area ratio per face of the thermoplastic polymer-containing layer relative to the porous substrate or inorganic filler-containing layer surface is preferably 3% or more, 4% or more, 5% or more, 10% or more, 20% or more, or 25% or more, and is preferably 90% or less, 80% or less, 70% or less, 60% or less, 55% or less, or 45% or less.

From the viewpoint of efficiently exhibiting the effects of the present embodiment, it is particularly preferable that the total coverage area ratio per face of the thermoplastic polymer-containing layer relative to the porous substrate surface be within the range of 20% to 45%.

From the viewpoint of efficiently exhibiting the effects of the present embodiment, it is particularly preferable that the total coverage area ratio per face of the thermoplastic polymer-containing layer relative to the inorganic filler-containing layer surface be within the range of 25% to 55%.

When the total coverage area ratio of the thermoplastic polymer-containing layer is less than the lower limit described above, the distance between the separator and the electrode interface will become uneven, resulting in uneven current distribution, which will lead to an increase in temperature during safety tests. Furthermore, when the total coverage area of the thermoplastic polymer-containing layer is larger than the upper limit described above, battery resistance may increase, leading to deterioration of rate characteristics.

Furthermore, when the total coverage area ratio of the thermoplastic polymer-containing layer is large, since there are many contact points between the thermoplastic polymer-containing layer and stainless steel (SUS304), or between the thermoplastic polymer-containing layer and the lithium metal oxide-containing face of a predetermined positive electrode f, the coefficient of dynamic friction μ′_{α} between a surface of the separator on the porous substrate side and stainless steel (SUS304) and the coefficient of dynamic friction μ′_{β} between a surface of the separator on the inorganic filler-containing layer side and a lithium metal oxide-containing face of a predetermined positive electrode f tend to increase.

The total coverage area ratio S of the thermoplastic polymer-containing layer present on the porous substrate surface or the inorganic filler-containing layer surface can be calculated from the following formula because the total exposed area of the porous substrate and the inorganic filler-containing layer is equal to the surface area of the porous substrate in top view observation:

S (%)=total coverage area of thermoplastic polymer-containing layer÷surface area of porous substrate×100

The coverage area ratio (%) of the coating pattern of the thermoplastic polymer-containing layer to the surface of the substrate can be measured using a microscope (model: VHX-7000, manufactured by Keyence Corporation). The coverage area ratio of the thermoplastic polymer is measured by photographing a sample separator at 30-fold magnification (coaxial epi-illumination), selecting automatic area measurement as the measurement mode. The coverage area ratio in each sample is determined by performing the above measurement three times and using the arithmetic average value thereof.

The total coverage area ratio of the thermoplastic polymer-containing layer can be adjusted by changing the polymer concentration of the coating liquid, the amount of polymer solution applied, the coating method, and the coating conditions.

### [Inorganic Filler-Containing Layer]

Furthermore, the separator for an energy storage device according to the present embodiment may comprise an inorganic filler-containing layer (in the present embodiment, the inorganic filler-containing layer may be referred to as a porous layer) containing an inorganic filler and a resin binder. The position of the inorganic filler-containing layer may be in at least a part of the porous substrate surface, at least a part of the thermoplastic polymer-containing layer surface, and/or between the porous substrate and the thermoplastic polymer-containing layer.

In an embodiment, the position of the inorganic filler-containing layer is between the polyolefin microporous membrane and the thermoplastic polymer-containing layer. The separator of the present embodiment may comprise an inorganic filler-containing layer on one or both faces of the porous substrate, and from the viewpoints of improving the pin removal properties and friction control as described above, and the viewpoint of the wound state of the separator and electrodes as shown in FIG. 1, it is preferable to provide the inorganic filler-containing layer on one face of the polyolefin microporous membrane and between the polyolefin microporous membrane and the thermoplastic polymer-containing layer.

In the inorganic filler-containing layer of the present embodiment, it is more preferable that the ratio T of the pores having an area in the range of 0.001 μm² to 0.05 μm² to the pores having an area of 0.001 μm² or more in the inorganic filler-containing layer be 90% or more.

### (Inorganic Filler)

The inorganic filler used in the inorganic filler-containing layer is not particularly limited, and it preferably has a melting point of 200° C. or higher, has high electrical insulation, and is electrochemically stable within the range of use of lithium-ion secondary batteries.

Examples of the material of the inorganic filler material include oxide-based ceramics such as alumina, silica, titania, zirconia, magnesia, ceria, yttria, zinc oxide, and iron oxide; nitride-based ceramics such as silicon nitride, titanium nitride, and boron nitride; ceramics such as silicon carbide, calcium carbonate, magnesium sulfate, aluminum sulfate, barium sulfate, aluminum hydroxide, aluminum hydroxide oxide or boehmite, potassium titanate, talc, kaolinite, dickite, nacrite, halloysite, pyrophyllite, montmorillonite, sericite, mica, amethyst, bentonite, asbestos, zeolite, calcium silicate, magnesium silicate, diatomaceous earth, and silica sand; as well as glass fibers. Among these, at least one selected from the group consisting of alumina, boehmite, and barium sulfate is preferable from the viewpoint of stability within a lithium-ion secondary battery. Further, as the boehmite, synthetic boehmite is preferable because it can reduce ionic impurities that adversely impact the characteristics of the electrochemical device.

Examples of the shape of the inorganic filler include plate-like, scale-like, polyhedral, needle-like, columnar, particulate, spherical, spindle-like, and block-like shapes, and multiple types of inorganic fillers having the above shapes may be used in combination. Among these, block-like shapes are preferable from the viewpoint of balance between permeability and heat resistance.

The aspect ratio of the inorganic filler is preferably 1.0 or more and 5.0 or less, and more preferably 1.1 or more and 3.0 or less. An aspect ratio of 5.0 or less is preferable from the viewpoint of suppressing the amount of moisture adsorbed by the multilayer porous membrane, suppressing capacity deterioration during repeated cycles, and suppressing deformation at temperatures exceeding the melting point of the polyolefin microporous membrane.

The specific surface area of the inorganic filler is preferably 3.0 m²/g or more and 17 m²/g or less, more preferably 5.0 m²/g or more and 15 m²/g or less, and further preferably 6.5 m²/g or more and 13 m²/g or less. It is preferable that the specific surface area be 17 m²/g or less from the viewpoint of suppressing the amount of moisture adsorbed by the multilayer porous membrane and suppressing capacity deterioration when repeated cycles, and it is preferable that the specific surface area be 3.0 m²/g or more from the viewpoint of suppressing deformation at temperatures exceeding the melting point of the polyolefin microporous membrane. The specific surface area of the inorganic filler is measured using the BET adsorption method.

In the particle size distribution of a slurry containing the inorganic filler, the volume average particle diameter D₅₀ of the inorganic filler particles is preferably 0.5 μm or less, more preferably within the range of 0.1 μm to 0.5 μm, and further preferably within the range of 0.2 μm to 0.4 μm. The D_{F} of the inorganic filler being 0.5 μm or less is preferable in order to increase the frictional force with the lithium metal oxide or the electrode active material, from the viewpoint of improving pin removal properties and friction control as described above, and the viewpoint of reducing the heat shrinkage rate of the separator comprising the inorganic filler-containing layer.

When D_{F} of the inorganic filler particles is small, the coffee ring phenomenon is suppressed when applying and drying the thermoplastic polymer-containing layer, making it easier for the thermoplastic polymer particles to pile up flat against the coated surface, and thus, there are many contact points between the thermoplastic polymer-containing layer on the inorganic filler-containing layer and the lithium metal oxide-containing face of the predetermined positive electrode f, whereby the coefficient of dynamic friction μ′_{β} between a surface of the separator on the inorganic filler-containing layer side and the lithium metal oxide-containing face of a predetermined positive electrode f tends to become large.

Regarding the particle size distribution and median diameter of the inorganic filler particles, the particle size distribution of the inorganic filler particle dispersion can be measured using a laser particle size distribution measuring device (Microtrac MT3300EX manufactured by Nikkiso Co., Ltd.). If necessary, the particle size distribution of the inorganic filler particle dispersion or slurry coating liquid can be adjusted using the particle size distribution of water or the binder polymer as a baseline. The particle size at which the cumulative frequency is 50% is defined as volume average particle diameter D₅₀, and the D₅₀ of the inorganic filler particles is defined as D_{F}.

Examples of the method for adjusting the particle size distribution of the inorganic filler as described above include a method of pulverizing the inorganic filler using a ball mill, bead mill, or jet mill to obtain the desired particle size distribution, and a method in which a plurality of fillers are prepared and then blended.

The proportion of the inorganic filler in the inorganic filler-containing layer can be determined as appropriate from the viewpoints of the adhesion of the inorganic filler and the permeability and heat resistance of the multilayer porous membrane, and is preferably 50% by weight or more and less than 100% by weight, more preferably 70% by weight or more and 99.99% by weight or less, further preferably 80% by weight or more and 99.9% by weight or less, and particularly preferably 90% by weight or more and 99% by weight or less.

### (Resin Binder)

Though the type of the resin binder is not particularly limited, but when the multilayer porous membrane of the present embodiment is used as a separator for a lithium-ion secondary battery, it is preferable to use a material that is insoluble in the electrolyte solution of the lithium-ion secondary battery and that is electrochemically stable within the range of use of the lithium-ion secondary battery.

Specific examples of the resin binder include the following 1) to 7):
1) polyolefins: for example, polyethylene, polypropylene, ethylene propylene rubber, and modified products thereof;
2) conjugated diene polymers: for example, styrene-butadiene copolymers and hydrides thereof, acrylonitrile-butadiene copolymers and hydrides thereof, and acrylonitrile-butadiene-styrene copolymers and hydrides thereof;
3) acrylic polymers: for example, methacrylic ester-acrylic ester copolymers, styrene-acrylic ester copolymers, and acrylonitrile-acrylic ester copolymers;
4) polyvinyl alcohol resins: for example, polyvinyl alcohol and polyvinyl acetate;
5) fluorine-containing resins: for example, polyvinylidene fluoride, polytetrafluoroethylene, vinylidene fluoride-hexafluoropropylene-tetrafluoroethylene copolymers, and ethylene-tetrafluoroethylene copolymers;
6) cellulose derivatives: FOR example, ethylcellulose, methylcellulose, hydroxyethylcellulose, and carboxymethylcellulose;
7) resins having a melting point and/or glass transition temperature of 180° C. or higher, or polymers without a melting point but having a decomposition temperature of 200° C. or higher: for example, polyphenylene ether, polysulfone, polyethersulfone, polyphenylene sulfide, polyetherimide, polyamideimide, polyamide, and polyester.

From the viewpoint of further improving safety in the event of a short circuit, 3) acrylic polymers, 5) fluorine-containing resins, and 7) polyamide as a polymer are preferable. As the polyamide, a wholly aromatic polyamide, and in particular, polymetaphenylene isophthalamide, is preferable from the viewpoint of durability.

From the viewpoint of compatibility between the resin binder and the electrode, the 2) conjugated diene polymers are preferable, and from the viewpoint of voltage resistance, the 3) acrylic polymers and 5) fluorine-containing resins are preferable.

The 2) conjugated diene polymers are polymers containing a conjugated diene compound as a monomer unit.

Examples of the conjugated diene compound include 1,3-butadiene, 2-methyl-1,3-butadiene, 2,3-dimethyl-1,3-butadiene, 2-chloro-1,3-butadiene, substituted linear conjugated pentadienes, substituted and side chain conjugated hexadienes, and these may be used alone or in combination of two or more thereof. Among these, 1,3-butadiene is particularly preferable.

The 3) acrylic polymers are polymers containing a (meth)acrylic compound as a monomer unit. The above (meth)acrylic compound refers to at least one selected from the group consisting of (meth)acrylic acid and (meth)acrylic acid ester.

Examples of the (meth)acrylic acid ester used in the 3) acrylic polymers include (meth)acrylic acid alkyl esters, such as methyl acrylate, methyl methacrylate, ethyl acrylate, ethyl methacrylate, butyl acrylate, butyl methacrylate, 2-ethylhexyl acrylate, and 2-ethylhexyl methacrylate; and epoxy group-containing (meth)acrylic esters, such as glycidyl acrylate and glycidyl methacrylate, and these may be used alone or in combination of two or more thereof. Among these, 2-ethylhexyl acrylate (EHA) and butyl acrylate (BA) are particularly preferable.

From the viewpoint of safety in a crash test, the acrylic polymer is preferably a polymer containing EHA or BA as a main constituent unit. The main constituent unit refers to a polymer portion corresponding to the monomer that accounts for 40 mol % or more of the total raw materials for forming the polymer.

The 2) conjugated diene polymers and 3) acrylic polymers may be obtained by copolymerizing these polymers with another monomer that is copolymerizable therewith. Other copolymerizable monomers that can be used include, for example, unsaturated carboxylic acid alkyl esters, aromatic vinyl monomers, vinyl cyanide monomers, unsaturated monomers containing a hydroxyalkyl group, unsaturated carboxylic acid amide monomers, crotonic acid, maleic acid, maleic anhydride, fumaric acid, and itaconic acid, and these may be used alone or in combination of two or more thereof. Among these, unsaturated carboxylic acid alkyl ester monomers are particularly preferable. Examples of unsaturated carboxylic acid alkyl ester monomers include dimethyl fumarate, diethyl fumarate, dimethyl maleate, diethyl maleate, dimethyl itaconate, monomethyl fumarate, and monoethyl fumarate, and these may be used alone or in combination of two or more thereof.

It should be noted that the 2) conjugated diene polymers may be obtained by copolymerizing a (meth)acrylic compound as the other monomer.

The resin binder is preferably in the form of latex, and more preferably an acrylic polymer latex, from the viewpoint that adhesion between multiple inorganic particles is strong even at high temperatures exceeding room temperature, and thermal shrinkage is suppressed.

The average particle diameter of the resin binder is preferably 50 nm or more and 500 nm or less, more preferably 60 nm or more and 460 nm or less, and further preferably 80 nm or more and 250 nm or less. In the case in which the average particle diameter of the resin binder is 50 nm or more, when an inorganic filler-containing layer containing an inorganic filler and a resin binder is stacked on at least one face of the polyolefin microporous membrane, the ion permeability is unlikely to decrease and high output characteristics can easily be obtained. Even when the temperature rises quickly during abnormal heat generation, it exhibits smooth shutdown characteristics, making it easy to obtain high safety. When the average particle diameter of the resin binder is 500 nm or less, suitable adhesion is exhibited, and when a multilayer porous membrane is formed, thermal shrinkage is suitable and safety tends to be excellent.

The average particle diameter of the resin binder can be controlled by adjusting the polymerization time, polymerization temperature, raw material composition ratio, raw material input order, and pH.

A dispersant such as a surfactant may be added to the inorganic filler application liquid in order to stabilize dispersion or improve coating properties. The dispersant adsorbs to the surface of the inorganic filler particles in the slurry and stabilizes the inorganic filler particles by electrostatic repulsion, and examples thereof include polycarboxylate, sulfonate, and polyoxyether. The amount of the dispersant added is preferably 0.2 parts by weight or more and 5.0 parts by weight or less, and more preferably 0.3 parts by weight or more and 1.0 part by weight or less in terms of solid content, relative to 100 parts by weight of the inorganic filler.

### (Physical Properties and Configuration of Inorganic Filler-Containing Layer)

The thickness of the inorganic filler-containing layer per layer is preferably 0.1 μm or more and 4.0 μm or less, more preferably 0.2 μm or more and 3.0 μm or less, further preferably 0.5 μm or more and 2.0 μm or less, and particularly preferably 1.0 μm or more and 1.5 μm or less. It is preferable that the thickness of the inorganic filler-containing layer be 0.1 μm or more from the viewpoint of preventing a deterioration of performance and safety due to the occurrence of micro short circuits due to the shrinkage stress of the substrate during storage tests, and suppressing deformation at temperatures exceeding the melting point of the microporous membrane. It is preferable that the thickness of the inorganic filler-containing layer be 4.0 μm or less from the viewpoint of increasing battery capacity, suppressing deterioration of rate characteristics, and suppressing the amount of moisture adsorbed by the multilayer porous membrane.

The layer density in the inorganic filler-containing layer is preferably 1.10 g/(m²·μm) or more and 3.00 g/(m²·μm) or less, more preferably 1.20 g/(m²·μm) or more and 2.90 g/(m²·μm) or less, more preferably 1.40 g/(m²·μm) or more and 2.70 g/(m²·μm) or less, and particularly preferably 1.50 g/(m²·μm) or more and 2.50 g/(m²·μm) or less. It is preferable that the layer density in the inorganic filler-containing layer be 1.10 g/(m²·μm) or more from the viewpoint of suppressing deformation at temperatures exceeding the melting point of the PO microporous membrane. It is preferable that the layer density in the inorganic filler-containing layer be 3.00 g/(m²·μm) or less from the viewpoint of maintaining the ion permeability of the inorganic filler-containing layer and suppressing capacity deterioration over repeated cycles.

### [Physical Properties and Configuration of Separator]

The lower limit of the total thickness of the separator for an energy storage device is preferably 3 μm or more, more preferably 4 μm or more, and further preferably 5 μm or more, and the upper limit is preferably 16 μm or less, more preferably 10 μm or less, and further preferably 9 μm or less. It is preferable that the total thickness be 3 μm or more from the viewpoint of ensuring the strength and safety of the separator for an energy storage device. Conversely, it is preferable that the total thickness be 16 μm or less because this lowers the electrical resistance of the energy storage device, improves the capacity of the energy storage device, and makes the separator according to the present embodiment exhibit suitable pin removal properties. The total thickness of the separator can be appropriately adjusted in accordance with, for example, the membrane forming conditions of the porous substrate, the stacked structure of the separator, and the forming conditions of the thermoplastic polymer-containing layer or the inorganic filler-containing layer.

From the viewpoint of improving the pin removal properties and friction control as described above, the ratio (MD/TD tensile breaking strength ratio) of the MD tensile breaking strength to the TD tensile breaking strength of the separator for an energy storage device is preferably 0.5 or more and 1.5 or less, more preferably 0.5 or more and 1.2 or less, and further preferably 0.5 or more and 1.0 or less. From the same point of view, the MD tensile breaking strength of the separator is preferably within the range of 1,000 to 1,500 kgf/cm², and more preferably within the range of 1,100 to 1,400 kgf/cm², and/or the TD tensile breaking strength of the separator is preferably within the range of 1,100 to 1,700 kgf/cm², and more preferably within the range of 1,200 to 1,600 kgf/cm². The tensile breaking strength and MD/TD tensile breaking strength ratio of the separator can be adjusted in accordance with, for example, in the separator production process, the design of the raw material composition constituting the porous substrate such as polyolefin microporous membrane, heat setting conditions, and coating conditions of the inorganic filler-containing layer or thermoplastic polymer-containing layer.

The lower limit of the basis weight of the separator for an energy storage device is preferably 4.0 g/m² or more, more preferably 5.0 g/m² or more, and further preferably 6.0 g/m² or more, and the upper limit is preferably 13.5 g/m² or less, more preferably 11.2 g/m² or less, and further preferably 9.9 g/m² or less. A basis weight of 4.0 g/m² or more is preferable from the viewpoint of ensuring strength and safety. Conversely, a basis weight of 13.5 g/m² or less is preferable from the viewpoint of obtaining suitable charge/discharge characteristics because it lowers the resistance of the battery.

The lower limit of the air permeability of the separator for an energy storage device is preferably 10 sec/100 cm³ or more, more preferably 20 sec/100 cm³ or more, further preferably 30 sec/100 cm³ or more, and most preferably 50 sec/100 cm³ or more, and the upper limit thereof is preferably 200 sec/100 cm³ or less, more preferably 180 sec/100 cm³ or less, further preferably 150 sec/100 cm³ or less, and most preferably 120 sec/100 cm³ or less. An air permeability of 10 sec/100 cm³ or more is preferable from the viewpoint of further suppressing the occurrence of micro short circuits and deterioration of performance and safety during storage tests when used as a separator for an energy storage device, and further suppressing self-discharge of the energy storage device. Conversely, an air permeability of 200 sec/100 cm³ or less is preferable from the viewpoint of obtaining suitable charge/discharge characteristics because it lowers the resistance of the battery. The air permeability of the separator for an energy storage device can be adjusted by changing the stretching temperature and stretching ratio, the area ratio of the thermoplastic polymer, and the presence form when producing the polyolefin microporous membrane.

The lower limit of the puncture strength of the separator for an energy storage device is preferably 200 gf or more, more preferably 300 gf or more, further preferably 400 gf or more, and particularly preferably 450 gf or more. A puncture strength of 200 gf or more is preferable from the viewpoint of suppressing membrane rupture due to dislodged active material when the separator is wound together with the electrode, the viewpoint of suppressing short circuits due to expansion and contraction of the electrodes due to charging and discharging, and the viewpoint of improving the impact resistance of the energy storage device. The upper limit of the puncture strength of the separator for an energy storage device is preferably 800 gf or less, more preferably 700 gf or less, and further preferably 600 gf or less from the viewpoint of reducing width shrinkage due to orientation relaxation during heating.

Regarding the heat shrinkage rate of the separator for an energy storage device, the TD heat shrinkage rate at 150° C. for 1 hour is preferably −3% or more and 10% or less, more preferably −1% or more and 8% or less, and further preferably 0% or more and 5% or less. When the TD heat shrinkage rate is −3% or more, the risk of short circuit between the electrodes due to twisting of the separator due to negative contraction (expansion) can be suppressed, and reductions in performance and safety can be suppressed. When the TD heat shrinkage rate is 10% or less, it is possible to suppress a decrease in performance and safety due to the occurrence of micro short circuits during storage tests. The heat shrinkage rate of the separator can be adjusted by appropriately combining the stretching operation and heat treatment of the substrate. At the same time as suppressing the TD heat shrinkage rate, the MD heat shrinkage rate is also preferably −3% or more and 10% or less, more preferably −1% or more and 8% or less, and further preferably 0% or more and 5% or less.

In the separator for an energy storage device, the shutdown temperature, which is an index of the safety of the energy storage device, is preferably 160° C. or lower, more preferably 155° C. or lower, further preferably 150° C. or lower, and most preferably 145° C. or lower.

In the separator for an energy storage device, the short circuit temperature, which is an indicator of heat resistance, is preferably 140° C. or higher, more preferably 150° C. or higher, and further preferably 160° C. or higher. When used as a separator for an energy storage device, it is preferable that the short-circuit temperature be 160° C. or higher from the viewpoint of safety of the energy storage device.

From the viewpoint of efficiently exhibiting the effects of the present embodiment, the separator preferably has an asymmetric multilayer structure with respect to the substrate, and more preferably has a multilayer structure in which the thermoplastic polymer-containing layer is formed on at least one surface (one or both faces) of the substrate, and the inorganic filler-containing layer, which contains the inorganic filler and a resin binder, is formed between at least one surface of the substrate and the thermoplastic polymer-containing layer.

### [Separator Production Method]

The method for the production of the separator for an energy storage device according to the present embodiment comprises, for example, the steps of:
preparing a porous substrate;
forming an inorganic filler-containing layer on one surface of the porous substrate,
forming a thermoplastic polymer-containing layer on the other surface of the porous substrate and the surface of the inorganic filler-containing layer, and
drying if desired.

### <Step of Preparing Porous Substrate>

The method for the production of a separator of the present embodiment comprises the step of preparing a porous substrate. The step of preparing the porous substrate includes, for example, forming a microporous membrane using the above method for producing a polyolefin microporous membrane, and surface treatment of the substrate, which will be described later.

### <Step of Forming Inorganic Filler-Containing Layer>

The method for the production of a separator of the present embodiment comprises the step of forming an inorganic filler-containing layer on at least one surface of the porous substrate. Examples of the method for forming the inorganic filler-containing layer include a method in which the inorganic filler-containing layer is formed by applying an application liquid containing an inorganic filler and a resin binder to at least one face of a polyolefin microporous membrane as the porous substrate.

The solvent for the application liquid is preferably one that can uniformly and stably disperse the inorganic filler and the resin binder, and examples thereof include N-methylpyrrolidone, N,N-dimethylformamide, N,N-dimethylacetamide, water, ethanol, toluene, hot xylene, methylene chloride, and hexane.

Various additives such as dispersants such as surfactants; thickeners; wetting agents; antifoaming agents; and pH adjusters containing acids and alkalis may be added to the application liquid to stabilize dispersion and improve the coating properties thereof. It is preferable that these additives be removed when removing the solvent, but if they are electrochemically stable within the usage range of lithium-ion secondary batteries, do not inhibit battery reactions, and are stable up to about 200° C., they may remain within the inorganic filler-containing layer.

The method of dispersing the inorganic filler and the resin binder in the solvent of the application liquid is not particularly limited as long as it is a method that can achieve the dispersion characteristics of the application liquid required for the application step. Examples thereof include mechanical agitation by means of a ball mill, bead mill, planetary ball mill, jet mill, vibrating ball mill, sand mill, colloid mill, attritor, roller mill, high-speed impeller dispersion, disperser, homogenizer, high-speed impact mill, ultrasonic dispersion, and stirring blades. Among these, from the viewpoint of improving the pin removal properties and friction control, and reducing the heat shrinkage rate of the separator comprising the inorganic filler-containing layer, it is preferable to grind the inorganic filler using a ball mill, bead mill, or jet mill, so that the D_{F} of the inorganic filler in the application liquid is 0.5 μm or less, and/or prepare inorganic fillers with multiple particle size distributions, and then blend.

The method of applying the application liquid to the microporous membrane is no particularly limited as long as the method can achieve the required layer thickness and application area, and examples thereof include the gravure coater method, small diameter gravure coater method, reverse roller coater method, transfer roller coater method, kiss coater method, dip coater method, knife coater method, air doctor coater method, blade coater method, rod coater method, squeeze coater method, cast coater method, die coater method, screen printing method, and spray application method.

It is preferable if the surface of the microporous membrane as a separator substrate is subjected to a surface treatment prior to applying the application liquid, because it makes it easier to apply the application liquid and improves the adhesion between the inorganic filler-containing layer and the surface of the microporous membrane after application. The surface treatment method is not particularly limited as long as it does not significantly damage the porous structure of the microporous membrane, and examples thereof include the corona discharge treatment method, mechanical roughening method, solvent treatment method, acid treatment method, and ultraviolet oxidation method.

The method for removing the solvent from the applied membrane after application is not particularly limited as long as it does not adversely affect the microporous membrane, and examples thereof include a method of drying at a temperature below its melting point while fixing the microporous membrane, and a method of drying under reduced pressure at a low temperature. It is preferable to dry under normal pressure from the perspective of preventing interference with the permeability of the separator, while exhibiting the binding between the binder polymer, which is the binding component of the resin binder, with the microporous membrane, which is the substrate, or with the inorganic filler-containing layer (porous layer), and the binding force between particulate binders. From the viewpoint of controlling the MD shrinkage stress of the microporous membrane and the separator, it is preferable to adjust the drying temperature and winding tension as appropriate.

### <Step of Forming Thermoplastic Polymer-Containing Layer>

The method for the production of a separator according to the present embodiment comprises the step of applying a slurry containing a thermoplastic polymer to at least one surface of the porous substrate and the surface of the inorganic filler-containing layer arranged on the other surface of the porous substrate to form the thermoplastic polymer-containing layer. The method for producing a separator according to another embodiment comprises the step of applying a slurry containing a thermoplastic polymer to only the surface of the inorganic filler-containing layer arranged on the surface of the porous substrate to form the thermoplastic polymer-containing layer.

In the formation of the thermoplastic polymer-containing slurry, from the viewpoints of improving pin removal properties and friction control, suppressing changes in the physical properties of thermoplastic polymers at high temperatures, and improving the safety of energy storage devices, it is preferable to select or blend the polymer raw materials and to design the thermoplastic resin so that in dynamic viscoelasticity measurement at 1 Hz, the tan δ value at 30° C. is within the range of 0.01 to 0.05, or so that the maximum temperature of tan δ value is at 70° C. or higher. From the same viewpoint, it is preferable to select or blend the polymer raw materials and to design the thermoplastic resin so as to achieve at least two glass transition temperatures, at least one of which is present in a region of lower than 20° C., and the other of which is present in a region of 30° C. or higher.

As the thermoplastic polymer, from the viewpoint of improving pin removal properties and friction control as described above, it is preferable to form the thermoplastic polymer-containing slurry using a copolymer of a monomer unit of a (meth)acrylic acid ester monomer and a monomer unit of another comonomer.

The thermoplastic polymer in the slurry preferably has an average particle diameter D_{P} of 100 nm or more and 800 nm or less from the viewpoint of friction control as described above.

The method of applying the slurry is not particularly limited, and examples thereof include a method of applying a slurry (application liquid) containing a thermoplastic polymer to a polyolefin microporous membrane.

The method of applying the application liquid containing the thermoplastic polymer to the porous substrate or the inorganic filler-containing layer is not particularly limited as long as the required layer thickness and application area can be achieved. Examples thereof include the gravure coater method, small diameter gravure coater method, reverse roll coater method, transfer roller coater method, kiss coater method, dip coater method, knife coater method, air doctor coater method, blade coater method, rod coater method, squeeze coater method, cast coater method, die coater method, screen printing method, spray application method, spray coater application method, and inkjet coating. Among these, the gravure coater method or the spray application method is preferable from the viewpoint of achieving a high degree of freedom in the coating shape of the thermoplastic polymer and easily obtaining a preferred area ratio. Furthermore, from the viewpoint of adjusting the dot-like pattern of the thermoplastic polymer-containing layer as described above, the gravure coater method, inkjet application, and application methods that allow easy adjustment of printing plates are preferable.

When coating a polyolefin microporous membrane with a thermoplastic polymer, if the application liquid penetrates into the interior of the microporous membrane, the adhesive resin will fill the surface and interior of the pores, reducing permeability. Thus, as the medium for the application liquid, a poor solvent for thermoplastic polymers is preferable.

When a poor solvent for thermoplastic polymers is used as the application liquid medium, the coating liquid does not enter the inside of the microporous membrane, and the adhesive polymer is mainly present on the surface of the microporous membrane, which is preferable from the viewpoint of suppressing a decrease in permeability. Water is preferred as such medium. The medium that can be used in combination with water is not particularly limited, and examples include ethanol and methanol. If desired, an antifoaming agent (for example, KM-73 manufactured by Shin-Etsu Chemical Co., Ltd., or SK-14 manufactured by Nissin Chemical Co., Ltd.) may be added to the thermoplastic polymer-containing application liquid.

From the viewpoint of friction control as described above, the application of the thermoplastic polymer to the polyolefin microporous membrane or inorganic filler-containing layer is preferably carried out so that the total coverage area ratio per face of the thermoplastic polymer-containing layer relative to the polyolefin microporous membrane surface or inorganic filler-containing layer surface is within the range of 10% to 70%, and/or the application pattern of the thermoplastic polymer-containing layer becomes dot-like. From the viewpoint of adjusting the dot-like pattern of the thermoplastic polymer-containing layer as described above, it is preferable to optimize the thermoplastic polymer-containing application liquid (also simply referred to as a paint) using the thermoplastic polymer and poor solvent described above.

Regarding the application liquid containing the thermoplastic polymer, from the viewpoint of achieving both adhesive strength with the electrodes and ion permeability, the application amount per face is preferably 0.03 g/m² or more and 0.50 g/m² or less, more preferably 0.04 g/m² or more and 0.30 g/m² or less, and most preferably 0.06 g/m² or more and 0.20 g/m² or less.

Regarding the thermoplastic polymer-containing application liquid, from the viewpoint of suppressing an increase in battery resistance and deterioration of rate characteristics, and from the viewpoint of suppressing cell temperature rise in (heating) safety tests caused by uneven current distribution due to uneven distance between the separator and the electrode interface, the thickness of the coating layer is preferably 0.1 μm or more and 10 μm or less, more preferably 0.2 μm or more and 5.0 μm or less, further preferably 0.3 μm or more and 4.0 μm or less, and particularly preferably 0.4 μm or more and 3.0 μm or less.

Furthermore, if the porous substrate as a separator substrate is subjected to surface treatment before application, it is preferable because it facilitates application of the application liquid, facilitates achieving the friction control described above, and improves adhesion between the porous substrate or inorganic filler-containing layer and the thermoplastic (adhesive) polymer. The surface treatment method is not particularly limited as long as it does not significantly damage the porous structure of the porous substrate, and examples thereof include the corona discharge treatment, plasma treatment, mechanical roughening, solvent treatment, acid treatment method, and ultraviolet oxidation method.

In the case of the corona discharge treatment method, from the viewpoint of adjusting the contact angle of the thermoplastic polymer-containing layer or separator with the electrolyte solution within the numerical range explained above, the corona treatment strength of the substrate surface is preferable in the range of 1 W/(m²/min) or more and 40 W/(m²/min) or less, more preferably in the range of 3 W/(m²/min) or more and 32 W/(m²/min) or less, and further preferably in the range of 5 W/(m²/min) or more and 25 W/(m²/min) or less. When the corona treatment strength is within the above range, hydrophilic groups are introduced to the surface of the substrate, which tends to improve affinity with the electrolyte solution and improve wettability. It is also preferable to carry out the corona discharge treatment after the dot-like pattern of the thermoplastic polymer-containing layer is formed by application.

The method for removing the solvent from the applied membrane after application is not particularly limited as long as it does not adversely affect the porous substrate. Examples thereof include a method of drying the porous substrate at a temperature below its melting point while fixing the porous substrate, a method of drying under reduced pressure at low temperature, and a method of coagulating the adhesive polymer and simultaneously extracting the solvent by immersing in a poor solvent for the adhesive polymer.

### <Drying Step>

In the production method of the present embodiment, it is preferable to perform the step of drying of the slurry containing the inorganic filler and/or the slurry containing the thermoplastic polymer after arranging the inorganic filler-containing layer on one face of the porous substrate and further arranging the thermoplastic polymer-containing layer on the other surface of the porous substrate and the surface of the inorganic filler-containing layer.

In the drying of the applied membrane, from the viewpoint of making it easier to achieve friction control as described above, the drying speed is preferably within the range of 0.03 g/(m²·s) or more and 4.0 g/(m²·s) or less, more preferably within the range of 0.05 g/(m²·s) or more and 3.5 g/(m²·s) or less, and further preferably within the range of 0.08 g/(m²·s) or more and 3.0 g/(m²·s) or less, and it is also preferable to raise the temperature by warming or heating to an extent that does not impact the particle shape of the thermoplastic polymer-containing layer.

### <Stack/Wound Body>

The stack according to the present embodiment is a stack of the separator and electrodes. The wound body according to the present embodiment is a wound stack. The separator of the present embodiment is adhered to an electrode for use as a stack or a wound body. The stack has excellent handling properties during winding and rate characteristics of an energy storage device, and also has excellent adhesion between the thermoplastic polymer-containing layer and the polyolefin microporous membrane and ion permeability. Thus, the application of the stack is not particularly limited, and it can suitably be applied to, for example, batteries such as non-aqueous electrolyte secondary batteries, condensers, and energy storage devices such as capacitors.

As the electrodes used in the stack of the present embodiment, those described in the section regarding the energy storage device described below can be used. The method for the production of a stack using the separator of the present embodiment is not particularly limited, and it can be produced by, for example, stacking the separator of the present embodiment and an electrode, and heating and/or pressing as necessary. Heating and/or pressing can be performed when stacking the electrodes and the separator.

Further, the wound body can be obtained by stacking the electrode and the separator and then winding them in a circular or flat spiral shape. In the winding step, circular or flat pins may be used, and the number of pins may be single or plural, and a pair of pins may be used. The pins are preferably made of stainless steel (SUS), such as SUS 430, 304, 201, or 600 from the viewpoint of the mechanism of action of the present invention and from the viewpoint of improving the pin removal properties. The winding step can be performed by, for example, winding the separator, a positive electrode, and a negative electrode around a pin, as shown in FIG. 1. If desired, the obtained wound body may be heated and/or pressed.

The stack can also be produced by stacking a positive electrode-separator-negative electrode-separator or negative electrode-separator-positive electrode-separator in this order in the form of a flat plate, optionally followed by heating and/or pressing. In the stacking, from the viewpoint of efficiently exhibiting the effects of the present invention, it is preferable that the side of the separator having the above inorganic filler-containing layer and the positive electrode be arranged to face each other with respect to the substrate of the separator.

More specifically, the separator of the present embodiment can be prepared as a vertically elongated separator having a width of 10 mm to 500 mm (and preferably 50 mm to 500 mm) and a length of 200 m to 4000 m (and preferably 1000 m to 4000 m), and the stack can be produced by stacking in the order of positive electrode-separator-negative electrode-separator or negative electrode-separator-positive electrode-separator and heating and/or pressing as necessary.

The heating temperature is preferably 40° C. to 120° C. The heating time is preferably 5 seconds to 30 minutes. The pressure during pressing is preferably 1 MPa to 30 MPa. The pressing time is preferably 5 seconds to 30 minutes. Further, the order of heating and pressing may be such that heating is performed first, then pressing is performed, pressing is performed first and then heating is performed, or pressing and heating are performed simultaneously. Among these, it is preferable to perform pressing and heating simultaneously.

### <Energy Storage Device>

The separator according to the present embodiment can be used as a separator in batteries, condensers, and capacitors, and for separating substances. In particular, when used as a separator for an energy storage device, it is possible to provide suitable adhesion to the electrodes and excellent battery performance. Hereinafter, a preferred embodiment of the case in which the energy storage device is a non-aqueous electrolyte secondary battery will be described.

The energy storage device according to the present embodiment comprises a positive electrode, a negative electrode, the separator for an energy storage device according to the present embodiment, and non-aqueous electrolyte solution. When producing a non-aqueous electrolyte secondary battery using the separator of the present embodiment, the positive electrode, negative electrode, and non-aqueous electrolyte solution are not particularly limited, and those which are known can be used. As the positive electrode of the energy storage device, for example, a predetermined positive electrode f may be used, or any known positive electrode other than the positive electrode f may be used as long as the effects of the present invention are achieved.

The positive electrode material is not particularly limited, and examples thereof include lithium-containing composite oxides such as LiCoO₂, LiNiO₂, spinel-type LiMnO₄, olivine-type LiFePO₄, and (L)NMC; as well as iron phosphate-based lithium compounds (LFP, LFMP).

The negative electrode material is not particularly limited, and examples thereof include carbon materials such as graphite, non-graphitizable carbonaceous materials, easily graphitizable carbonaceous materials, and composite carbon bodies; silicon, tin, metallic lithium, and various alloy materials.

The non-aqueous electrolyte solution is not particularly limited, and an electrolyte solution in which an electrolyte is dissolved in an organic solvent can be used. Examples of the organic solvent include propylene carbonate, ethylene carbonate, dimethyl carbonate, diethyl carbonate, and ethyl methyl carbonate. Examples of the electrolyte include lithium salts such as LiClO₄, LiBF₄, and LiPF₆.

Though the method for the production of an energy storage device using the separator of the present embodiment is not particularly limited, when the energy storage device is a secondary battery, for example, the energy storage device can be produced by preparing, as the separator of the present embodiment, a vertically elongated separator having a width of 10 mm to 500 mm (and preferably 80 mm to 500 mm) and a length of 200 m to 4000 m (and preferably 1000 m to 4000 m), subjecting the separator to stacking in the order of positive electrode-separator-negative electrode-separator or negative electrode-separator-positive electrode-separator, and winding in a circular or flat spiral shape to obtain a wound body, housing the wound body in a battery housing such as a battery can, and injecting an electrolyte solution thereinto. At this time, the wound body may be heated and/or pressed if desired. The above stack is wound in a circular or flat spiral shape and can be used as the wound body in the production.

The energy storage device can be obtained also by laminating with a bag-like film a stack obtained by stacking a positive electrode-separator-negative electrode-separator or negative electrode-separator-positive electrode-separator in this order in the shape of a flat plate, or the above stack, followed by a step of injecting an electrolyte solution and optionally a step of heating and/or pressing. The step of heating and/or pressing can be performed before and/or after the step of injecting the electrolyte solution.

In the energy storage device comprising a positive electrode, a negative electrode, the separator according to the present embodiment, and a non-aqueous electrolyte solution, from the viewpoint of efficiently exerting the effects of the present invention, the separator is preferably arranged such that the side having the inorganic filler-containing layer described above faces the positive electrode with respect to the porous substrate.

The energy storage device of the present embodiment can also be produced by a method similar to the method for producing batteries used in the rate characteristic test, cycle characteristic test, evaluation test for the pin removal properties from the wound body, etc., described in the Examples below.

It should be noted that the measured values of the various parameters described above are values measured according to the measurement methods in Examples described later, unless otherwise specified.

### EXAMPLES

The present invention will be described in detail below based on Examples and Comparative Examples, but the present invention is not limited to the Examples. The measurement methods and evaluation methods of the various physical properties used in the following Production Examples, Examples, and Comparative Examples are as follows. It should be noted that unless otherwise specified, the various measurements and evaluations were performed at a room temperature of 23° C., 1 atm, and a relative humidity of 50%.

### [Measurement Methods]

### <Viscosity Average Molecular Weight (Hereinafter Also Referred to as “Mv”)>

Based on ASRM-D4020, the intrinsic viscosity [η] of a decalin solvent at 135° C. was determined, and the Mv of polyethylene was calculated using the following formula:

$$[ η ] = 0.00068 \times {Mv}^{0.67}$$

The Mv of polypropylene was calculated from the following formula:

$$[ η ] = 1.1 \times {10}^{- 4} {Mv}^{0.8}$$

### <Volume Average Particle Diameter D50 of Thermoplastic Polymer Particles and Inorganic Filler Particles>

Regarding the particle size distribution and median diameter of inorganic filler particles or thermoplastic polymer particles, the particle size distribution of the inorganic filler particle dispersion or the slurry coating liquid containing the thermoplastic polymer particles was measured using a laser particle size distribution measuring device (Microtrac MT3300EX manufactured by Nikkiso Co., Ltd.). If necessary, the particle size distribution of the inorganic filler particle dispersion or slurry coating liquid was adjusted using the particle size distribution of water or binder polymer as a baseline. The particle size at which the cumulative frequency was 50% was defined as D₅₀, the D₅₀ of the inorganic filler particles was defined as D_{F}, and the D₅₀ of the thermoplastic polymer particles was defined as D_{P}.

### <Basis Weight of Polyolefin Microporous Membrane and Basis Weight Per Face of Thermoplastic Polymer-Containing Layer>

A 10 cm×10 cm square sample was cut from a polyolefin porous substrate or a polyolefin porous substrate+inorganic filler-containing layer, and the weight was measured using an electronic balance AEL-200 manufactured by Shimadzu Corporation. The basis weight (g/m²) of the membrane per m² was calculated by multiplying the obtained weight by 100.

A 10 cm×10 cm square sample was cut from a separator in which a thermoplastic polymer-containing layer was formed on a polyolefin porous substrate or a polyolefin porous substrate+inorganic filler-containing layer, and the weight was measured using an electronic balance AEL-200. The basis weight (g/m²) of the separator per m² was calculated by multiplying the obtained weight by 100.

The basis weight per face of the thermoplastic polymer-containing layer was calculated from the difference in basis weight between the polyolefin porous substrate or polyolefin porous substrate+inorganic filler-containing layer and the separator.

Alternatively, the basis weight per face of the thermoplastic polymer-containing layer may be calculated from the weight loss rate using a thermogravimetric differential thermal analyzer (NEXTA STA 200RV, manufactured by Hitachi High-Tech Science Co., Ltd.) by peeling off the thermoplastic polymer-containing layer from the surface of a 10 cm×10 cm square sample.

### <Porosity of Polyolefin Microporous Membrane (%)>

A 10 cm×10 cm square sample was cut from the polyolefin microporous membrane, the volume (cm³) and mass (g) thereof were determined, and the porosity was calculated using the following formula, assuming a membrane density of 0.95 (g/cm³).

$$Porosity = ( volume - mass / membrane density ) / volume \times 100$$

<Air Permeability of Polyolefin Microporous Membrane and Separator (sec/100 cm³)>

In accordance with JIS P-8117, the air permeabilities of the polyolefin microporous membrane and the separator were measured using a Gurley air permeability meter G-B2 ™ manufactured by Toyo Seiki Co., Ltd.

### <Thickness of Separator>

The thickness of the separator was measured at room temperature (23±2° C.) using a micro thickness meter “KBM™” manufactured by Toyo Seiki Co., Ltd.

### <Heat Shrinkage Rate>

As a sample, a separator was cut 100 mm in the MD and 100 mm in the TD, and allowed to stand in an oven at 150° C. for 1 hour. At this time, the sample was interposed between two sheets of paper so that the hot air did not directly hit the sample. After removing the sample from the oven and cooling, the length (mm) was measured, and the heat shrinkage rate was calculated using the following formula. Measurements were performed in the MD and the TD, and the rate in the TD was expressed as the heat shrinkage rate.

$$Heat shrinkage rate ( \% ) = \{ ( 100 - length of sample after heating ) / 100 \} \times 100$$

### <Measurement of Degree of Swelling of Thermoplastic Polymer>

The thermoplastic polymer particles were dried under vacuum for 12 hours at a temperature below their melting point, and the solvent was completely removed to obtain dried thermoplastic polymer particles. Approximately 0.5 g of the obtained dried product was weighed and defined as the weight before immersion (WA). This dried product was placed in a 50 mL vial along with 15 g of an electrolyte solution of ethylene carbonate (EC):ethyl methyl carbonate (EMC)=1:2 (volume ratio) containing 1 mol/L LiPF₆ and 1 wt % vinylene carbonate at 25° C., allowed to be immersed for 72 hours, and thereafter, the sample was removed, and immediately after wiping it with towel paper, its mass was measured, and the mass was determined as the weight after immersion (WB).

The electrolyte-solution swelling degree of the thermoplastic polymer-containing layer was calculated using the following formula.

$$Degree of swelling ( fold ) = WB / WA$$

In the above formula, if the material of the thermoplastic polymer-containing layer neither swelled nor dissolved in the electrolyte solution, the degree of swelling was 1-fold.

### <Glass Transition Temperature (° C.) of Thermoplastic Polymer>

An appropriate amount of a thermoplastic polymer coating liquid (non-volatile content=30%) was placed on an aluminum plate and dried in a hot air dryer at 130° C. for 30 minutes. Approximately 5 mg of the dried membrane was packed into an aluminum container for measurement, and a DSC curve and a DDSC curve were obtained in a nitrogen atmosphere using a DSC measurement device (DSC Q2000, manufactured by TA Instruments). The measurement conditions were as follows:

### (First Stage Temperature Increase Program)

Starting at 40° C., the temperature increases at a rate of 50° C. per minute. After reaching 200° C., the temperature is maintained for 5 minutes.

### (Second Stage Temperature Reduction Program)

The temperature is reduced from 200° C. at a rate of 20° C. per minute. After reaching −50° C., the temperature is maintained for 5 minutes.

### (Third Stage Temperature Increase Program)

The temperature is increased from −50° C. to 200° C. at a rate of 20° C. per minute. DSC and DDSC data are acquired during this third stage temperature increase.

According to the method described in JIS-K7121, the intersection of the baseline (the straight line given by extending the baseline in the obtained DSC curve toward the high temperature side) and the tangent at the inflection point (the point where the upwardly convex curve changes to a downwardly convex curve) is the glass transition temperature (Tg).

### <Dot Diameter>

The dot diameter of the coating pattern was measured using a microscope (model: VHX-7000, manufactured by Keyence Corporation). A sample separator was photographed at 100 times magnification (coaxial epi-illumination), the diameters of a plurality (5 points) of dots were measured in the measurement mode, and the average value thereof was calculated as the dot diameter.

### <Coverage Area Ratio (%) of Thermoplastic Polymer-Containing Layer to Substrate or Inorganic Filler-Containing Layer Surface>

The coverage area ratio of the coating pattern of the thermoplastic polymer-containing layer to the surface of the substrate or inorganic filler-containing layer was measured using a microscope (model: VHX-7000, manufactured by Keyence Corporation). After photographing a sample separator at 30 times magnification (coaxial epi-illumination), automatic area measurement was selected as the measurement mode, and the coverage area ratio of the thermoplastic polymer was measured. The coverage area ratio in each sample was determined by performing the above measurement three times and the arithmetic average value thereof was defined as the coverage area ratio.

### <Thickness Measurement of Microporous Membrane and Coating Layer>

A sample separator was cross-sectionally processed using a BIB (broad ion beam). The cross-sectional processing was performed using an IM4000 manufactured by Hitachi High-Tech Corporation under processing conditions of argon beam type, acceleration voltage of 3 kV, and beam current of 25 to 35 μA. During processing, in order to suppress thermal damage, the samples were allowed to cool until just before processing, if necessary. Specifically, the samples were left in a cooling device at −40° C. all day and night. As a result, a smooth cross section of the separator was obtained.

The height of the thermoplastic polymer-containing layer was measured using a scanning electron microscope (SEM) (model: S-4800, manufactured by HITACHI). The sample with osmium deposited was observed under conditions of an acceleration voltage of 1.0 kV and 5000 times magnification, and the thicknesses of the polyolefin microporous membrane and inorganic filler-containing layer were measured at 5 observation points, and the arithmetic average value was calculated for each.

The thickness of the thermoplastic polymer-containing layer was calculated by subtracting the thickness of the polyolefin microporous membrane and the inorganic filler-containing layer calculated by the method described above from the thickness of the separator obtained by measuring at room temperature (23±2° C.) using a micro thickness meter “KBM™” manufactured by Toyo Seiki Co., Ltd.

### <Dynamic Viscoelasticity>

Approximately one heaping spoonful of each thermoplastic polymer shown in Table 3-1 or Table 3-2, which had been thoroughly dried in a fume hood, was placed on a 7 cm square piece of Lumirror film, and heated at 150° C. and 1 MPa for 2 min, and then pressed to prepare a film-like sample.

The produced film was cut into 5 mm×30 mm strips, and the temperature was raised from 25° C. to 200° C. with the frequency fixed at 1 Hz using the tensile mode of DMAQ850 manufactured by TA Instruments Japan.

Regarding dynamic viscoelasticity, tan δ and the maximum value of tan δ at 30° C. were observed.

<Tensile Breaking Strength (kgf/cm²)>

MD and TD samples (shape: width 10 mm×length 100 mm) were measured in accordance with JIS K7127 using a tensile tester, Autograph AG-A Type™ manufactured by Shimadzu Corporation. The distance between the chucks of the tensile tester was 50 mm, and Cellophane® tape (manufactured by Nitto Denko Packaging Systems Co., Ltd., product name: N.29) was attached to one face of both ends (each 25 mm) of the sample. In order to prevent the sample from slipping during the test, 1 mm thick fluororubber was attached to the inside of the chuck of the tensile tester.

It should be noted that measurement was performed under conditions of a temperature of 23±2° C., a chuck pressure of 0.40 MPa, and a tensile speed of 100 mm/min.

The tensile breaking strength (MPa) was determined by dividing the strength of the polyolefin microporous membrane or separator at break by the cross-sectional area of the sample before the test.

The tensile breaking strength was determined for each of the MD and the TD, and not only the MD and TD tensile breaking strengths, but also the MD/TD tensile breaking strength ratios were calculated and displayed.

### <Dynamic Friction Measurement>

### (Friction Test)

Regarding the face of the separator sample on which the covering layer was formed, the coefficient of dynamic friction was calculated by measuring in the MD three times under the conditions of a thread mass of 200 g, a load range of 2 N, a contact element area of 63 mm×63 mm (felt material), a contact element feeding speed of 100 mm/min, a measurement distance of 30 mm, a temperature of 23° C., and a humidity of 50% using an MH-3 friction tester manufactured by Toyo Seiki Seisakusho Co., Ltd, and determining the average value thereof.

The table serving as the counterpart material was adjusted in accordance with the measured coefficient of dynamic friction.

When measuring the coefficient of dynamic friction μ′_{α} with SUS, an SUS304 6F processed product (pre-processing: plate milling special #200 buffing+nitriding+finishing, buffing: unified processing direction (width direction processing), polishing with special #200 count (tolerance approximately #200 to #230)) table was used.

When measuring the coefficient of dynamic friction μ′_{β} with the lithium metal oxide (LiCoO₂)-containing face, a table with a positive electrode f (described later) attached to the above table was used.

μ′_{α}/μ′_{β} was calculated using μ′_{α} and μ′_{β} measured as described above, and is shown in the table.

### Positive Electrode f for Measurement of Coefficient of Dynamic Friction μ′_{β}

90.4% by weight of LiCoO₂ (manufactured by Enertech) as the positive electrode active material, 5.4% by weight of carbon black (Super-P Li) as a conductive material, and 4.2% by weight of polyvinylidene fluoride (PVdF) (density 1.75 g/cm³) as a binder were mixed, and dispersed in N-methylpyrrolidone (NMP) to prepare a slurry. This slurry was applied using a die coater to both faces of a 15 μm thick aluminum foil serving as a positive electrode current collector so as to achieve an L/W of 36 mg/cm², and after drying at 130° C. for 3 minutes, a positive electrode f having a lithium metal oxide (LiCoO₂)-containing face was produced by compression molding using a roller press machine. The energy density of the positive electrode f was 5.47 mAh/cm². The surface roughness Sq of the positive electrode was 0.6, and the contact angle with water was 1220.

For the surface roughness Sq of the positive electrode, the value of the surface roughness parameter Sq (root mean square height), which was calculated by observing the electrode surface with a confocal laser microscope (Olympus OLS5000 SA F), was used.

For the contact angle of the positive electrode with water, using a contact angle meter (CA-V) (model name) manufactured by Kyowa Interface Science Co., Ltd., 2 μL of water was dropped onto the positive electrode surface, and the value of the contact angle after 40,000 milliseconds had elapsed was adopted.

### <Preparation of Electrodes for Separator Adhesion and Pin Removal Properties Tests>

### Positive and Negative Electrodes for Separator Adhesion Test

Positive electrode (manufactured by Enertech, positive electrode material: LiCOo₂, conductive aid: carbon black (Super-P Li), binder: PVDF, L/W: 36 mg/cm² on both sides, thickness of A1 current collector: 15 μm, 5.47 mAh/cm²)
Negative electrode (manufactured by Enertech, negative electrode material: graphite, conductive aid: carbon black (Super-P Li), binder: PVDF, L/W: 20 mg/cm² on both sides, thickness of Cu current collector: 10 μm, 5.75 mAh/cm²)

### <Preparation of Electrolyte Solution for Separator Adhesion Test>

An electrolyte solution was prepared by dissolving LiPF₆ as a solute at a concentration of 1 mol/L in a mixed solvent of ethylene carbonate (EC):ethyl methyl carbonate (EMC)=1:2 (volume ratio) containing 1 wt % vinylene carbonate.

### <Preparation of Positive Electrode and Negative Electrode for Rate Characteristics and Cycle Characteristics Tests>

90.4% by weight of nickel, manganese, cobalt composite oxide (NMC) (Ni:Mn:Co=1:1:1 (element ratio), density 4.70 g/cm³) as the positive electrode active material, 1.6% by weight of graphite powder (KS6) (density 2.26 g/cm³, number average particle diameter 6.5 μm) as a conductive additive, 3.8% by weight of acetylene black powder (AB) (density 1.95 g/cm³, number average particle diameter 48 nm), and 4.2% by weight of polyvinylidene fluoride (PVdF) (density 1.75 g/cm³) as a binder were mixed and dispersed in N-methylpyrrolidone (NMP) to prepare a slurry. This slurry was applied to one face of a 20 μm thick aluminum foil that would serve as a positive electrode current collector using a die coater, and after drying at 130° C. for 3 minutes, a positive electrode was produced by compression molding using a roller press machine. The amount of positive electrode active material applied at this time was 109 g/m²

87.6% by weight of graphite powder A (density 2.23 g/cm³, number average particle diameter 12.7 μm) and 9.7% by weight of graphite powder B (density 2.27 g/cm³, number average particle diameter 6.5 μm) as a negative electrode active material, 1.4% by weight (solid content equivalent) of an ammonium salt of carboxymethylcellulose as a binder (solid content concentration 1.83% by weight aqueous solution), and 1.7% by weight (solid content equivalent) of diene rubber latex (solid content concentration 40% by weight aqueous solution) were dispersed in purified water to prepare a slurry. This slurry was applied to one face of a 12 μm thick copper foil that would serve as the negative electrode current collector with a die coater, and after drying at 120° C. for 3 minutes, a negative electrode was produced by compression molding using a roller press machine. The amount of negative electrode active material applied at this time was 5.2 g/m²

### <Preparation of Non-Aqueous Electrolyte Solution for Rate Characteristics and Cycle Characteristics Tests>

A non-aqueous electrolyte solution was prepared by dissolving LiPF₆ as a solute at a concentration of 1.0 mol/L in a mixed solvent of ethylene carbonate:ethyl methyl carbonate=1:2 (volume ratio).

### (Battery Assembly)

The separator or substrate was cut into a 24 mm diameter circle, and the positive electrode and negative electrode for measuring rate characteristics and cycle characteristics were each cut into a 16 mm diameter circle. The negative electrode, the separator or substrate, and the positive electrode were stacked in this order so that the active materials of the positive electrode and negative electrode faced each other, and housed in a stainless metal container with a lid. The container and the lid were insulated, the container was in contact with the copper foil of the negative electrode, and the lid was in contact with the aluminum foil of the positive electrode. A battery (energy storage device) was assembled by injecting 0.4 mL of the non-aqueous electrolyte solution for measuring rate characteristics and cycle characteristics into this container and sealing the container.

<Pin Removal Properties after Battery Winding>

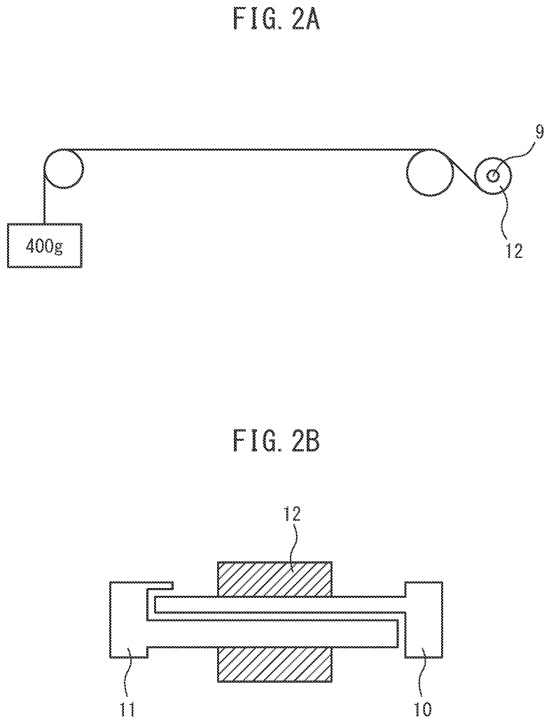

Using a manual winding machine manufactured by Kaito Seisakusho Co., Ltd., a rolled sample (12) with a length of 3 m and a width of 60 mm was prepared by winding two separators and one positive electrode and one negative electrode for separator adhesion test, with a total of the four being stacked as shown in FIG. 1, around a pin (9) under a load of 400 g as shown in FIG. 2A, which shows the overall configuration of the device, and thereafter in the winding part configuration shown in FIG. 2B, by removing the pin I (10), and pulling by hand and removing the wound sample (12) from the pull pin II (11), the pin removal properties were evaluated in accordance with the following criteria based on the wound appearance of the sample from which the pin had been removed.
A (Good): the ratio where the pin contact part which is pulled by the pin and deviates by 2 mm or more as compared to before the pin is removed is 1 or less/100
B (OK): the ratio where the pin contact part which is pulled by the pin and deviates by 2 mm or more as compared to before the pin is removed is 2 to 4/100
C (Poor): the ratio where the pin contact part which is pulled by the pin and deviates by 2 mm or more as compared to before the pin is removed was 5 to 9/100
D (Extremely Poor): the ratio where the pin contact part which is pulled by the pin and deviates by 2 mm or more as compared to before the pin is removed is 10 or more/100

### <Wet Adhesion to Electrode>

The separator for an energy storage device obtained in each Example and Comparative Example was cut into a rectangular shape having a width of 20 mm and a length of 70 mm, and a positive electrode and a negative electrode for adhesion test as an adherend were each cut into a rectangular shape having a width of 15 mm and a length of 60 mm.

A stack was obtained by stacking such that the thermoplastic polymer-containing layer of the separator and the positive electrode active material or negative electrode active material of the positive electrode or negative electrode faced each other.

The stack was placed in a rectangular aluminum pouch having a width of 60 mm and a length of 120 mm, 0.4 mL of an electrolyte solution at 25° C. was added thereto and allowed to stand at 25° C. for 12 hours, and thereafter, the aluminum pouch containing the stack was pressed under the following conditions.
Pressing pressure: 1 MPa
Temperature: 90° C.
Pressing time: 1 min

Regarding the stack after pressing, using force gauges ZP5N and MX2-500N (product name) manufactured by Imada Co., Ltd., a 90° peel test was conducted at a peeling rate of 50 mm/min by fixing the electrode, gripping and pulling the separator, and measuring the peel strength.

The peel strength between the thermoplastic polymer-containing layer and the negative electrode on the porous substrate surface side was defined as W1, the peel strength between the thermoplastic polymer-containing layer and the positive electrode on the inorganic filler-containing layer surface side was defined as W2, the larger value of W1 and W2 was defined as the wet adhesive strength of the sample. In a configuration in which the thermoplastic polymer-containing layer was provided on only one face of the substrate, only the wet adhesive strength on the side where the thermoplastic polymer-containing layer was present was measured.

Wet adhesion was evaluated according to the following criteria according to the wet adhesive strength value.
A (Good): Wet adhesive strength of 3 N/m or more
B (OK): Wet adhesive strength of 1 N/m or more and less than 3 N/m
C (Poor): Wet adhesive strength of less than 1 N/m

### <Rate Characteristics>

The first charge after battery fabrication was performed for a total of about 6 hours by a method wherein after charging the assembled simple battery at 25° C. at a current value of 3 mA (about 0.5 C) to a battery voltage of 4.2 V, reduction of the current value from 3 mA was started while maintaining 4.2 V. Thereafter, the battery was discharged to a voltage of 3.0 V at a current value of 3 mA. Next, charging was performed for a total of approximately 3 hours by a method wherein after charging the battery to a battery voltage of 4.2 V at 25° C. at a current value of 6 mA (approximately 1.0 C), reduction of the current value from 6 mA was started while maintaining 4.2 V. Thereafter, the discharge capacity when the battery was discharged to a battery voltage of 3.0 V at a current value of 6 mA was defined as the 1 C discharge capacity (mAh). Next, charging was performed for a total of approximately 3 hours by a method wherein after charging the battery to a battery voltage of 4.2 V at 25° C. at a current value of 6 mA (approximately 1.0 C), reduction of the current value from 6 mA was started while maintaining 4.2 V. Thereafter, the discharge capacity when the battery was discharged to a battery voltage of 3.0 V at a current value of 12 mA (approximately 2.0 C) was defined as the 2 C discharge capacity (mAh). The ratio of the 2 C discharge capacity to the 1 C discharge capacity was calculated, and this value was taken as the rate characteristics.

$$Rate characteristics ( \% ) = ( 2 C discharge capacity / 1 C discharge capacity ) \times 100$$

Evaluation criteria for rate characteristics (%):
A (Good): rate characteristics exceed 85%
B (OK): rate characteristics exceed 80% and is 85% or less
C (Poor): rate characteristics are 80% or less

### <Cycle Characteristics>

The battery subjected to the above <Rate Characteristics> test was discharged at a temperature of 25° C. to a discharge end voltage of 3 V at a discharge current of 1 C, and then charged to a charge end voltage of 4.2 V at a charge current of 1 C. This was regarded as one cycle, and charging and discharging were repeated. The cycle characteristics were evaluated based on the following criteria using the capacity retention rate after 300 cycles with respect to the initial capacity (capacity in the first cycle).
A (Good): capacity retention rate of 65% or more
B (OK): capacity retention rate of 60% or more and less than 65%
C (Poor): capacity retention rate of less than 60%

### Example 1

### (Production of Polyolefin Microporous Membrane B1)

45 parts by weight of a homopolymer high-density polyethylene having an Mv of 700,000, 45 parts by weight of a homopolymer high-density polyethylene having an Mv of 300,000, and 5 parts by weight of a homopolymer polypropylene having an Mv of 400,000 were dry blended using a tumbler blender. 1 part by weight of tetrakis-[methylene-(3′,5′-di-t-butyl-4′-hydroxyphenyl) propionate]methane as an antioxidant was added to 99 parts by weight of the obtained polyolefin mixture, and the mixture was again dry-blended using a tumbler blender to obtain a mixture. The obtained mixture was fed to a twin-screw extruder by a feeder under a nitrogen atmosphere. Additionally, liquid paraffin (kinematic viscosity 7.59×10⁻⁵ m²/s at 37.78° C.) was injected into the extruder cylinder using a plunger pump. The operating conditions of the feeder and pump were adjusted so that the proportion of liquid paraffin in the entire extruded mixture was 68 parts by weight, i.e., the polymer concentration was 32 parts by weight.

Next, these were melt-kneaded in a twin-screw extruder while heating to 160° C., the obtained melt-kneaded product was extruded through a T-die onto a cooling roller having a surface temperature which was controlled to 80° C., and the extrudate was cast in contact with the cooling roller, and cooled and solidified to obtain a sheet-like molded body. This sheet was stretched using a simultaneous biaxial stretching machine at a magnification and temperature that satisfied the physical properties of B1 listed in Table 1, was then immersed in methylene chloride to extract and remove the liquid paraffin, and dried. It was stretched using a tenter stretching machine under the conditions of a temperature and magnification that satisfied the physical properties of B1 listed in Table 1. Thereafter, this stretched sheet was relaxed by approximately 10% in the width direction and heat treated to obtain a polyolefin microporous membrane B1.

Regarding the obtained polyolefin microporous membrane B1, the physical properties (basis weight per face of the membrane, porosity, air permeability, and thickness) were measured by the above methods as necessary.

### (Production of Polyolefin Microporous Membranes B2 to B6)

Polyolefin microporous membranes B2 to B6 were obtained in the same manner as B1, except that the production conditions were changed as appropriate so as to satisfy the physical properties shown in Table 1 (membrane basis weight, porosity, air permeability, and thickness). The obtained polyolefin microporous membranes B2 to B6 were evaluated by the above methods. The obtained results are also shown in Table 1.

### [Preparation of Inorganic Filler-Containing Slurry]

### (Preparation of Inorganic Filler-Containing Slurry C1)

As shown in Table 2, 100 parts by weight of water and 0.5 parts by weight (in terms of solid content) of an aqueous ammonium polycarboxylate solution were mixed into 94.6 parts by weight of aluminum hydroxide oxide (boehmite, block-shaped, volume average particle diameter D_{F}=0.4 μm) as inorganic particles, and bead mill treatment was carried out. The bead mill treatment was carried out under the conditions of a bead diameter of 0.1 mm and a rotation speed in the mill of 2000 rpm. To the treated mixed solution, 0.2 parts by weight in terms of solid content of xanthan gum as a thickener and 4.7 parts by weight in terms of solid content of acrylic latex (solid content concentration 40%) were added to prepare an inorganic paint (hereinafter referred to also as inorganic filler-containing slurry) C1.

### (Preparation of Inorganic Filler-Containing Slurries C2 to C5)

As shown in Table 2, inorganic filler-containing slurries C2 to C5 were obtained by changing the production conditions of the inorganic paint.

### [Preparation of Thermoplastic Polymer Aqueous Dispersion]

### (Preparation of Thermoplastic Polymer Aqueous Dispersion P1)

To a reactor comprising a stirrer, a reflux condenser, a dropper, and a thermometer, 70.4 parts by weight of ion-exchanged water, 0.5 parts by weight of “Aqualon KH1025” (registered trademark, 25% aqueous solution manufactured by DKS Co., Ltd., indicated as “KH1025” in the tables; the same applies hereinafter), and 0.5 parts by weight of “Adekaria Soap SR1025” (registered trademark, manufactured by ADEKA Co., Ltd., 25% aqueous solution, indicated as “SR1025” in the tables; the same applies hereinafter) were added, and the internal temperature of the reaction vessel was raised to 95° C. Thereafter, while maintaining the internal temperature of the container at 95° C., 7.5 parts by weight of ammonium persulfate (2% aqueous solution) (denoted as “APS (aq)” in the tables; the same applies hereinafter) was added.

A mixture containing 34.6 parts by weight of methyl methacrylate, 22.5 parts by weight of n-butyl acrylate, 33.4 parts by weight of 2-ethylhexyl acrylate, 1.5 parts by weight of 2-hydroxyethyl methacrylate, 4 parts by weight of acrylamide, 2.8 parts by weight of glycidyl methacrylate, 0.7 parts by weight of trimethylolpropane triacrylate, 0.3 parts by weight of γ-methacryloxypropyltrimethoxysilane, 3 parts by weight of “Aqualon KH1025” (registered trademark, 25% aqueous solution manufactured by DKS Co., Ltd.), 3 parts by weight of “Adekaria Soap SR1025” (registered trademark, 25% aqueous solution manufactured by ADEKA Co., Ltd.), 0.05 parts by weight of sodium p-styrenesulfonate, 0.7 parts by weight of trimethylolpropane triacrylate (manufactured by Shin Nakamura Chemical Co., Ltd.), 0.3 parts by weight of γ-methacryloxypropyltrimethoxysilane, 7.5 parts by weight of ammonium persulfate (2% aqueous solution), and 52 parts by weight of ion-exchanged water was mixed for 5 minutes using a homomixer to prepare an emulsion.

The obtained emulsion was dropped into the reaction vessel from the dropping tank. Dropping was started 5 minutes after adding the aqueous ammonium persulfate solution to the reaction vessel, and the entire amount of the emulsion was added dropwise over 150 minutes. During the dropping of the emulsion, the internal temperature of the vessel was maintained at 95° C.

After the emulsion was added dropwise, the internal temperature of the reaction vessel was maintained at 95° C. for 90 minutes, and then cooled to room temperature to obtain an emulsion. The obtained emulsion was adjusted to pH=9.0 using an ammonium hydroxide aqueous solution (25% aqueous solution) to obtain an acrylic copolymer latex (thermoplastic polymer aqueous dispersion P1) having a concentration of 40% by weight.

### (Preparation of Thermoplastic Polymer Aqueous Dispersions P2 to P6)

Copolymer latexes (thermoplastic polymer aqueous dispersions) P2 to P6 were obtained in the same manner as the thermoplastic polymer P1, except that the compositions of the monomers and the other raw materials were changed as shown in Table 3-1, and the physical properties of each were evaluated. The obtained results are also shown in Table 3-1.

The abbreviations of the raw material names of Table 3-1 and Table 3-2 described below have the following meanings.

### <Emulsifier>

KH1025: “Aqualon KH1025”®, manufactured by DKS Co., Ltd., 25% aqueous solution
SR1025: “Adekaria Soap SR1025”®, manufactured by ADEKA Co., Ltd., 25% aqueous solution
NaSS: Sodium p-styrene sulfonate

### <Initiator>

APS (aq): Ammonium persulfate (2% aqueous solution)

### <Monomer>

### ((Meth)acrylic Acid Monomer)

MAA: Methacrylic acid
AA: Acrylic acid

### ((Meth)acrylic Acid Ester)

MMA: Methyl methacrylate
BA: n-butyl acrylate EHA: 2-ethylhexyl acrylate
CHMA: cyclohexyl methacrylate

### (Cyano Group-Containing Monomer)

AN: Acrylonitrile

### (Other Functional Group-Containing Monomers)

HEMA: 2-hydroxyethyl methacrylate
AM: Acrylamide

### (Crosslinkable Monomer)

GMA: Glycidyl methacrylate
A-TMPT: Trimethylolpropane triacrylate
AcSi: γ-methacryloxypropyltrimethoxysilane

### (Preparation of Thermoplastic Polymer Aqueous Dispersion P2-1)

Aqueous dispersion P2-1 was synthesized by taking a part of thermoplastic polymer aqueous dispersion P2 and performing multistage polymerization using this as a seed polymer. Specifically, first, a mixture containing 20 parts by weight in terms of solid content of aqueous dispersion P2, 0.5 parts by weight of Aqualon KH1025®, 0.5 parts by weight of Adekaria Soap SR10259, and 70.4 parts by weight of ion-exchanged water was placed in a reaction vessel comprising a stirrer, a reflux condenser, a dropping tank, and a thermometer, and the internal temperature of the reaction vessel was raised to 95° C. Thereafter, 7.5 parts by weight of ammonium persulfate (2% aqueous solution) was added while maintaining the internal temperature of the vessel at 95° C. The above is the initial preparation.

A mixture containing 10 parts by weight of 2-ethylhexyl acrylate, 33 parts by weight of cyclohexyl methacrylate, 1 part by weight of methacrylic acid, 1 part by weight of acrylic acid, 55 parts by weight of acrylonitrile, 2.0 parts by weight of “Aqualon KH1025” (registered trademark, 25% aqueous solution), 1.0 part by weight of trimethylolpropane triacrylate, 0.5 parts by weight of γ-methacryloxypropyltrimethoxysilane, 7.5 parts by weight of ammonium persulfate (2% aqueous solution), and 52 parts by weight of ion-exchanged water was mixed for 5 minutes using a homomixer to prepare an emulsion. The obtained emulsion was dropped into the reaction vessel from the dropping tank. Dropping was started 5 minutes after adding the aqueous ammonium persulfate solution to the reaction vessel, and the entire amount of the emulsion was added dropwise over 150 minutes. During the dropping of the emulsion, the internal temperature of the container was maintained at 95° C.

After the emulsion was added dropwise, the internal temperature of the reaction vessel was maintained at 95° C. for 90 minutes, and then cooled to room temperature to obtain an emulsion. The resulting emulsion was adjusted to pH=9.0 using an ammonium hydroxide aqueous solution (25% aqueous solution) to obtain an acrylic copolymer latex (thermoplastic polymer aqueous dispersion P2-1) having a concentration of 40% by weight. The physical properties were evaluated using the above methods.

### (Preparation of Thermoplastic Polymer Aqueous Dispersions P2-2 to P6-2)

Copolymer latexes (aqueous dispersion of thermoplastic polymers) P2-2 to P6-2 were obtained by multistage polymerization in the same manner as the raw material polymer (aqueous dispersion) P2-1, except that the compositions of the seed polymer, monomer, and other raw materials were changed as described in Table 3-2, and the physical properties of each were evaluated by the above methods.

### (Thermoplastic Polymer Aqueous Dispersion PVDF)

As the PVDF listed in Table 4, commercially available polyvinylidene fluoride (PVDF-HFP copolymer, glass transition temperature: −35° C., degree of swelling: 2-fold, average particle diameter D₅₀: 200 nm) was used.

### [Preparation of Thermoplastic Polymer-Containing Paint]

### (Preparation of Thermoplastic Polymer-Containing Paint A1)

As shown in Table 4, 10 parts by weight of a polymer first component P1 containing acrylic resin as a main component (Tg: −6° C., degree of swelling in electrolyte solution: 2-fold, volume average particle diameter D_{P}: 132 nm), and 90 parts by weight of a polymer second component P2-2 containing acrylic resin as the main component (Tg: 95° C., degree of swelling in electrolyte solution: 8-fold, volume average particle diameter D_{P}: 500 nm) were combined to prepare a thermoplastic polymer-containing paint A1. The dynamic viscoelasticity of the thermoplastic polymer-containing paint A1 was measured as described above, and the measurement results are also shown in Table 4.

### (Preparation of Thermoplastic Polymer-Containing Paints A2 to A6)

As shown in Table 4, thermoplastic polymer-containing paints A2 to A6 were prepared in the same manner as thermoplastic polymer-containing paint A1, except that the blending amounts of the polymer second component or the polymer first and second components were changed, and the physical properties were evaluated. The obtained results are also shown in Table 4.

### [Formation of Inorganic Filler-Containing Layer]

As shown in Table 5, one face of the porous substrate B1 of the polyolefin microporous membrane was coated with the inorganic filler-containing slurry C1 so that the coating layer thickness was 1.5 μm to form an inorganic filler-containing layer.

[Coating Polyolefin Microporous Membrane with Thermoplastic Polymer-Containing Layer]

The surface side of the porous substrate B1 of the polyolefin microporous membrane and the surface side of the inorganic filler-containing layer were each coated with the thermoplastic polymer-containing paint A1 by gravure or inkjet printing so as to achieve the coating shape, coverage area, or dot diameter shown in Table 5, whereby a separator for an energy storage device comprising a thermoplastic polymer-containing layer (first layer) on the surface side of the porous substrate B1 and a thermoplastic polymer-containing layer (second layer) on the surface side of the inorganic filler-containing layer was obtained. The obtained separator was evaluated by the above methods. The results obtained are also shown in Table 5.

### Examples 2 to 18, Comparative Examples 1 to 8

Separators comprising a thermoplastic polymer-containing layer (first layer) on the surface side of the porous substrate and a thermoplastic polymer-containing layer (second layer) on the surface side of the inorganic filler-containing layer were obtained in the same manner as in Example 1, except that the porous substrate, the inorganic filler-containing slurry or its coating conditions, and the thermoplastic polymer-containing paint or its coating conditions were changed as shown in Table 5. The obtained separators were evaluated by the above methods. The results obtained are also shown in Table 5.

TABLE 1
Porous substrate

| | Polyolefin porous substrate No. | | | | | |
|---|---|---|---|---|---|---|
| | B1 | B2 | B3 | B4 | B5 | B6 |
| Thickness (μm) | 6 | 4 | 6 | 12 | 3 | 12 |
| Basis weight (g/m²) | 3.5 | 3.3 | 3.3 | 6.4 | 1.8 | 7 |
| Porosity (%) | 40 | 37 | 42 | 44 | 40 | 40 |
| Air permeability | 100 | 140 | 90 | 144 | 50 | 200 |
| (sec/100 cm³) | | | | | | |

TABLE 2
Inorganic filler-containing slurry

| | | C1 | C2 | C3 | C4 | C5 |
|---|---|---|---|---|---|---|
| Inorganic filler material | — | AlO(OH) | BaSO₄ | AlO(OH) | Al₂O₃ | AlO(OH) |
| Inorganic filler form | — | Block-like | Spherical | Block-like | Block-like | Block-like |
| Inorganic filler average | μm | 0.4 | 0.3 | 0.3 | 0.5 | 0.7 |
| particle diameter D50 (D_{F}) | | | | | | |

TABLE 3-1
Thermoplastic polymer aqueous solution (Acrylic)

| | | Raw | Active ingredient | | | | | | |
|---|---|---|---|---|---|---|---|---|---|
| | | material | percentage | Acrylic | | | | | |
| | Type | name | or unit | P1 | P2 | P3 | P4 | P5 | P6 |
| Initial | Emulsifier | KH1025 | 25% | 0.5 | 0.5 | 0.5 | 0.5 | 0.5 | 0.5 |
| preparation | | SR1025 | 25% | 0.5 | 0.5 | 0.5 | 0.5 | 0.5 | 0.5 |
| | Ion-exchanged water | | — | 70.4 | 70.4 | 70.4 | 70.4 | 70.4 | 70.4 |
| | Initiator | APS (aq) | 2% | 7.5 | 7.5 | 7.5 | 7.5 | 7.5 | 7.5 |
| Emulsion | Ar vinyl compound monomer | St | | 0 | 20.0 | 0 | 30.0 | 10.0 | 0 |
| | Acid monomer | MAA | 100% | 0.1 | 1.0 | 1.0 | 1.0 | 1.0 | 1.0 |
| | | AA | 100% | 0.1 | 1.0 | 1.0 | 1.0 | 1.0 | 1.0 |
| | (Meth)acrylic acid ester | MMA | 100% | 34.6 | 11.2 | 0 | 0 | 19.0 | 0 |
| | | BA | 100% | 22.5 | 0 | 0 | 0 | 6.2 | 0 |
| | | EHA | 100% | 33.4 | 4.6 | 0.7 | 13.2 | 0 | 9.9 |
| | | CHMA | 100% | 0 | 0 | 9.3 | 1.3 | 0 | 32.5 |
| | Cyano group-containing monomer | AN | 100% | 0 | 60.7 | 86.5 | 52.0 | 61.3 | 54.2 |
| | Functional group-containing | HEMA | 100% | 1.5 | 0 | 0 | 0 | 0 | 0 |
| | monomer | AM | 100% | 4.0 | 0 | 0 | 0 | 0 | 0 |
| | Crosslinkable monomer | GMA | 100% | 2.8 | 0 | 0 | 0 | 0 | 0 |
| | | A-TMPT | 100% | 0.7 | 1.0 | 1.0 | 1.0 | 1.0 | 1.0 |
| | | AcSi | 100% | 0.3 | 0.5 | 0.5 | 0.5 | 0.5 | 0.5 |
| | Emulsifier | KH1025 | 25% | 3.0 | 2.0 | 2.0 | 2.0 | 2.0 | 2.0 |
| | | SR1025 | 25% | 3.0 | 0 | 0 | 0 | 0 | 0 |
| | | NaSS | 100% | 0.05 | 0 | 0 | 0 | 0 | 0 |
| | Initiator | APS (aq) | 2% | 7.5 | 7.5 | 7.5 | 7.5 | 7.5 | 7.5 |

| | | | | | | | |
|---|---|---|---|---|---|---|---|
| Ion-exchanged water | — | 52.0 | 52.0 | 52.0 | 52.0 | 52.0 | 52.0 |
| Glass transition temperature (Tg) | ° C. | −6 | 95 | 100 | 68 | 95 | 67 |
| Degree of swelling | -fold | 2 | 8 | 7 | 10 | 8 | 10 |
| Average particle diameter D50 (D_{P}) | nm | 132 | 150 | 150 | 150 | 150 | 150 |

TABLE 3-2
Thermoplastic polymer aqueous solution (Acrylic)

| | | Raw | Active ingredient | | | | | | | | | | |
|---|---|---|---|---|---|---|---|---|---|---|---|---|---|
| | | material | percentage | Acrylic | | | | | | | | | |
| | Type | name | or unit | P2-1 | P2-2 | P3-1 | P3-2 | P4-1 | P4-2 | P5-1 | P5-2 | P6-1 | P6-2 |
| Initial | Seed polymer type | | — | P2 | P2-1 | P3 | P3-1 | P4 | P4-1 | P5 | P5-1 | P6 | P6-1 |
| preparation | Seed polymer diameter | | (nm) | 150 | 280 | 150 | 280 | 150 | 280 | 150 | 280 | 150 | 280 |
| | Seed polymer amount | | 100% | 20 | 13 | 20 | 13 | 20 | 13 | 20 | 13 | 20 | 13 |
| | Emulsifier | KH1025 | 25% | 0.5 | 0.5 | 0.5 | 0.5 | 0.5 | 0.5 | 0.5 | 0.5 | 0.5 | 0.5 |
| | | SR1025 | 25% | 0.5 | 0.5 | 0.5 | 0.5 | 0.5 | 0.5 | 0.5 | 0.5 | 0.5 | 0.5 |
| | Ion-exchanged water | | — | 70.4 | 70.4 | 70.4 | 70.4 | 70.4 | 70.4 | 70.4 | 70.4 | 70.4 | 70.4 |
| | Initiator | APS(aq) | 2% | 7.5 | 7.5 | 7.5 | 7.5 | 7.5 | 7.5 | 7.5 | 7.5 | 7.5 | 7.5 |
| Emulsion | Acid monomer | MAA | 100% | 1 | 1 | 1 | 1 | 1 | 1 | 1 | 1 | 1 | 1 |
| | | AA | 100% | 1 | 1 | 1 | 1 | 1 | 1 | 1 | 1 | 1 | 1 |
| | (Meth)acrylic acid | EHA | 100% | 10 | 10 | 10 | 10 | 10 | 10 | 10 | 10 | 10 | 10 |
| | ester | CHMA | 100% | 33 | 33 | 33 | 33 | 33 | 33 | 33 | 33 | 33 | 33 |
| | Cyano group- | AN | 100% | 55 | 55 | 55 | 55 | 55 | 55 | 55 | 55 | 55 | 55 |
| | containing monomer | | | | | | | | | | | | |
| | Crosslinkable | A-TMPT | 100% | 1 | 1 | 1 | 1 | 1 | 1 | 1 | 1 | 1 | 1 |
| | monomer | AcSi | 100% | 0.5 | 0.5 | 0.5 | 0.5 | 0.5 | 0.5 | 0.5 | 0.5 | 0.5 | 0.5 |
| | Emulsifier | KH1025 | 25% | 2 | 2 | 2 | 2 | 2 | 2 | 2 | 2 | 2 | 2 |
| | Initiator | APS (aq) | 2% | 7.5 | 7.5 | 7.5 | 7.5 | 7.5 | 7.5 | 7.5 | 7.5 | 7.5 | 7.5 |

| | | | | | | | | | | | | |
|---|---|---|---|---|---|---|---|---|---|---|---|---|
| | Ion-exchanged water | — | 52 | 52 | 52 | 52 | 52 | 52 | 52 | 52 | 52 | 52 |
| Physical | Glass transition temperature (Tg) | (° C.) | 95 | 95 | 100 | 100 | 68 | 68 | 95 | 95 | 62 | 62 |
| properties | Average particle diameter D50 (D_{P}) | (nm) | 280 | 500 | 280 | 500 | 280 | 500 | 280 | 550 | 280 | 590 |

TABLE 4
Thermoplastic polymer-containing paint

| | | | | Polymer | | | | | |
|---|---|---|---|---|---|---|---|---|---|
| | | | | A1 | A2 | A3 | A4 | A5 | A6 |
| Physical | First | Main component | | Acrylic P1 | Acrylic P1 | Acrylic P1 | Acrylic P1 | Acrylic P1 | Acrylic P1 |
| properties | component | Content | Parts | 10 | 10 | 10 | 10 | 10 | 20 |
| | Second | Main component | | Acrylic P2-2 | Acrylic P3-2 | Acrylic P4-2 | Acrylic P5-2 | PVDF | Acrylic P6-2 |
| | component | Content | Parts | 90 | 90 | 90 | 90 | 90 | 80 |

| | | | | | | |
|---|---|---|---|---|---|---|
| tan δ at 30° C. | 0.03 | 0.01 | 0.05 | 0.07 | 0.09 | 0.10 |
| Maximum value of tan δ (° C.) | 102 | 110 | 70 | 96 | <25° C. | 66 |

TABLE 5-1

| | | | | | Ex 1 | Ex 2 | Ex 3 | Ex 4 | Ex 5 | Ex 6 |
|---|---|---|---|---|---|---|---|---|---|---|
| Membrane | Polyolefin microporous membrane | | | | B1 | B1 | B1 | B1 | B1 | B1 |
| configuration | Inorganic filler- | | Raw material slurry No. | | C1 | C1 | C1 | C1 | C1 | C1 |
| | containing layer | | Coating layer | μm | 1.5 | 1.5 | 1.5 | 1.5 | 1.5 | 1.5 |
| | | | thickness | | | | | | | |
| | Thermoplastic | First layer | Raw material polymer No. | | A1 | A1 | A1 | A1 | A1 | A1 |
| | polymer- | (porous | Coating form | | Dots | Dots | Dots | Dots | Dots | Dots |
| | containing | substrate | Coverage area | % | 40 | 30 | 50 | 20 | 30 | 40 |
| | layer | surface | Dot diameter | μm | 220 | 220 | 220 | 220 | 220 | 220 |
| | | side) | Coefficient | — | 0.45 | 0.43 | 0.47 | 0.37 | 0.40 | 0.45 |
| | | | of dynamic | | | | | | | |
| | | | friction | | | | | | | |
| | | | μ′_{α} between | | | | | | | |
| | | | first layer | | | | | | | |
| | | | and SUS | | | | | | | |

| Second layer | Raw material polymer No. | | A1 | A1 | A1 | A1 | A1 | A1 |
|---|---|---|---|---|---|---|---|---|
| (inorganic | Coating form | | Dots | Dots | Dots | Dots | Dots | Dots |
| filler- | Coverage area | % | 40 | 30 | 50 | 20 | 40 | 30 |
| containing | Dot diameter | μm | 220 | 220 | 220 | 220 | 220 | 220 |
| layer | Coefficient | — | 0.55 | 0.53 | 0.56 | 0.51 | 0.55 | 0.53 |
| surface | of dynamic | | | | | | | |
| side) | friction | | | | | | | |
| | μ′_{β} between | | | | | | | |
| | second layer | | | | | | | |
| | and Li metal | | | | | | | |
| | oxide-containing | | | | | | | |
| | face of positive | | | | | | | |
| | electrode f | | | | | | | |

| | | | | | | | | |
|---|---|---|---|---|---|---|---|---|
| Physical | μ′_{α}/μ′_{β} | — | 0.82 | 0.81 | 0.84 | 0.73 | 0.73 | 0.85 |
| properties | Total thickness | μm | 8.5 | 8.5 | 8.5 | 8.5 | 8.5 | 8.5 |
| | MD tensile breaking strength | kgf/cm² | 1300 | 1300 | 1300 | 1300 | 1300 | 1300 |
| | TD tensile breaking strength | kgf/cm² | 1600 | 1600 | 1600 | 1600 | 1600 | 1600 |
| | MD/TD tensile breaking strength ratio | — | 0.81 | 0.81 | 0.81 | 0.81 | 0.81 | 0.81 |
| | 150° C. heat shrinkage rate | % | 2 | 2 | 2 | 2 | 2 | 2 |
| | Pin removal properties | — | A | A | A | A | A | A |
| | Wet adhesion | — | A | B | A | B | A | A |
| | Blocking property | — | A | A | A | A | A | A |

| | | | | | | | |
|---|---|---|---|---|---|---|---|
| Battery | Rate characteristics | A | A | B | A | A | A |
| characteristics | Cycle characteristics | A | A | A | A | A | A |

| | | | Ex 7 | Ex 8 | Ex 9 | Ex 10 |
|---|---|---|---|---|---|---|
| Membrane | Polyolefin microporous membrane | | B1 | B1 | B1 | B2 |
| configuration | Inorganic filler- | Raw material slurry No. | C1 | C1 | C1 | C1 |

| containing layer | | Coating layer | μm | 1.5 | 1.5 | 1.5 | 1.5 |
|---|---|---|---|---|---|---|---|
| | | thickness | | | | | |
| Thermoplastic | First layer | Raw material polymer No. | | A1 | A2 | A3 | A1 |
| polymer- | (porous | Coating form | | Dots | Dots | Dots | Dots |
| containing | substrate | Coverage area | % | 70 | 40 | 40 | 40 |
| layer | surface | Dot diameter | μm | 220 | 220 | 220 | 220 |
| | side) | Coefficient | — | 0.59 | 0.50 | 0.42 | 0.50 |
| | | of dynamic | | | | | |
| | | friction | | | | | |
| | | μ′_{α} between | | | | | |
| | | first layer | | | | | |
| | | and SUS | | | | | |

| Second layer | Raw material polymer No. | | A1 | A2 | A3 | A1 |
|---|---|---|---|---|---|---|
| (inorganic | Coating form | | Dots | Dots | Dots | Dots |
| filler- | Coverage area | % | 70 | 40 | 40 | 40 |
| containing | Dot diameter | μm | 220 | 220 | 220 | 220 |
| layer | Coefficient | — | 0.67 | 0.59 | 0.5 | 0.55 |
| surface | of dynamic | | | | | |
| side) | friction | | | | | |
| | μ′_{β} between | | | | | |
| | second layer | | | | | |
| | and Li metal | | | | | |
| | oxide-containing | | | | | |
| | face of positive | | | | | |
| | electrode f | | | | | |

| | | | | | | |
|---|---|---|---|---|---|---|
| Physical | μ′_{α}/μ′_{β} | — | 0.88 | 0.85 | 0.82 | 0.91 |
| properties | Total thickness | μm | 8.5 | 8.5 | 8.5 | 6.5 |
| | MD tensile breaking strength | kgf/cm² | 1300 | 1300 | 1300 | 1400 |
| | TD tensile breaking strength | kgf/cm² | 1600 | 1600 | 1600 | 1200 |
| | MD/TD tensile breaking strength ratio | — | 0.81 | 0.81 | 0.81 | 1.17 |
| | 150° C. heat shrinkage rate | % | 2 | 2 | 2 | 2 |
| | Pin removal properties | — | A | A | A | B |
| | Wet adhesion | — | A | B | A | A |
| | Blocking property | — | A | A | C | A |

| | | | | | |
|---|---|---|---|---|---|
| Battery | Rate characteristics | C | A | A | A |
| characteristics | Cycle characteristics | B | A | A | A |

TABLE 5-2

| | | | | | Ex 11 | Ex 12 | Ex 13 | Ex 14 | Ex 15 |
|---|---|---|---|---|---|---|---|---|---|
| Membrane | Polyolefin microporous membrane | | | | B5 | B1 | B1 | B6 | B1 |
| configuration | Inorganic filler- | | Raw material slurry No. | | C1 | C2 | C3 | C1 | C1 |
| | containing layer | | Coating layer | μm | 1.5 | 1.0 | 1.0 | 1.5 | 2.0 |
| | | | thickness | | | | | | |
| | Thermoplastic | First layer | Raw material polymer No. | | A1 | A1 | A1 | A1 | — |
| | polymer- | (porous | Coating form | | Dots | Dots | Dots | Dots | — |
| | containing | substrate | Coverage area | % | 40 | 40 | 40 | 40 | — |
| | layer | surface | Dot diameter | μm | 220 | 220 | 220 | 220 | — |
| | | side) | Coefficient | — | 0.45 | 0.45 | 0.46 | 0.45 | 0.48 |
| | | | of dynamic | | | | | | |
| | | | friction | | | | | | |
| | | | μ′_{α} between | | | | | | |
| | | | first layer | | | | | | |
| | | | and SUS | | | | | | |

| Second layer | Raw material polymer No. | | A1 | A1 | A1 | A1 | A1 |
|---|---|---|---|---|---|---|---|
| (inorganic | Coating form | | Dots | Dots | Dots | Dots | Dots |
| filler- | Coverage area | % | 40 | 40 | 40 | 40 | 50 |
| containing | Dot diameter | μm | 220 | 220 | 220 | 220 | 220 |
| layer | Coefficient | — | 0.55 | 0.57 | 0.56 | 0.55 | 0.60 |
| surface | of dynamic | | | | | | |
| side) | friction | | | | | | |
| | μ′_{β} between | | | | | | |
| | second layer | | | | | | |
| | and Li metal | | | | | | |
| | oxide-containing | | | | | | |
| | face of positive | | | | | | |
| | electrode f | | | | | | |

| | | | | | | | |
|---|---|---|---|---|---|---|---|
| Physical | μ′_{α}/μ′_{β} | — | 0.82 | 0.79 | 0.82 | 0.82 | 0.80 |
| properties | Total thickness | μm | 5.5 | 8.5 | 8.5 | 14.5 | 9.0 |
| | MD tensile breaking strength | kgf/cm² | 1200 | 1300 | 1300 | 2000 | 1300 |
| | TD tensile breaking strength | kgf/cm² | 1500 | 1600 | 1600 | 2500 | 1600 |
| | MD/TD tensile breaking strength ratio | — | 0.80 | 0.81 | 0.81 | 0.80 | 0.81 |
| | 150° C. heat shrinkage rate | % | 2 | 2 | 2 | 10 | 5 |
| | Pin removal properties | — | B | A | A | A | A |
| | Wet adhesion | — | A | A | A | A | A |
| | Blocking property | — | A | A | A | A | A |

| | | | | | | |
|---|---|---|---|---|---|---|
| Battery | Rate characteristics | A | A | A | C | B |
| characteristics | Cycle characteristics | A | A | A | C | A |

| | | | Ex 16 | Ex 17 | Ex 18 |
|---|---|---|---|---|---|
| Membrane | Polyolefin microporous membrane | | B1 | B1 | B1 |
| configuration | Inorganic filler- | Raw material slurry No. | C1 | C1 | C4 |

| containing layer | | Coating layer | μm | 1.5 | 1.5 | 1.5 |
|---|---|---|---|---|---|---|
| | | thickness | | | | |
| Thermoplastic | First layer | Raw material polymer No. | | A1 | A1 | A1 |
| polymer- | (porous | Coating form | | Uniform | Dots | Dots |
| containing | substrate | | | dispersion | | |
| layer | surface | Coverage area | % | 70 | 15 | 40 |
| | side) | Dot diameter | μm | — | 220 | 220 |
| | | Coefficient | — | 0.63 | 0.35 | 0.46 |
| | | of dynamic | | | | |
| | | friction | | | | |
| | | μ′_{α} between | | | | |
| | | first layer | | | | |
| | | and SUS | | | | |

| Second layer | Raw material polymer No. | | A1 | A1 | A1 |
|---|---|---|---|---|---|
| (inorganic | Coating form | | Uniform | Dots | Dots |
| filler- | | | dispersion | | |
| containing | Coverage area | % | 70 | 15 | 40 |
| layer | Dot diameter | μm | — | 220 | 220 |
| surface | Coefficient | — | 0.77 | 0.49 | 0.50 |
| side) | of dynamic | | | | |
| | friction | | | | |
| | μ′_{β} between | | | | |
| | second layer | | | | |
| | and Li metal | | | | |
| | oxide-containing | | | | |
| | face of positive | | | | |
| | electrode f | | | | |

| | | | | | |
|---|---|---|---|---|---|
| Physical | μ′_{α}/μ′_{β} | — | 0.82 | 0.71 | 0.92 |
| properties | Total thickness | μm | 8.5 | 8.5 | 8.5 |
| | MD tensile breaking strength | kgf/cm² | 1300 | 1300 | 1300 |
| | TD tensile breaking strength | kgf/cm² | 1600 | 1600 | 1600 |
| | MD/TD tensile breaking strength ratio | — | 0.81 | 0.81 | 0.81 |
| | 150° C. heat shrinkage rate | % | 2 | 2 | 2 |
| | Pin removal properties | — | A | C | C |
| | Wet adhesion | — | A | B | A |
| | Blocking property | — | A | A | A |

| | | | | |
|---|---|---|---|---|
| Battery | Rate characteristics | C | A | A |
| characteristics | Cycle characteristics | C | A | B |

TABLE 5-3

| | | | | | Comp | Comp | Comp | Comp | Comp |
|---|---|---|---|---|---|---|---|---|---|
| | | | | | Ex 1 | Ex 2 | Ex 3 | Ex 4 | Ex 5 |
| Membrane | Polyolefin microporous membrane | | | | B4 | B4 | B1 | B3 | B5 |
| configuration | Inorganic filler- | | Raw material slurry No. | | C5 | C5 | C1 | C1 | C1 |
| | containing layer | | Coating layer | μm | 4 | 4 | 1.5 | 1.5 | 1.5 |
| | | | thickness | | | | | | |
| | Thermoplastic | First layer | Raw material polymer No. | | A6 | A6 | A4 | A4 | A4 |
| | polymer- | (porous | Coating form | | Dots | Dots | Dots | Dots | Dots |
| | containing | substrate | Coverage area | % | 20 | 70 | 40 | 40 | 40 |
| | layer | side) | Dot diameter | μm | 220 | 220 | 220 | 220 | 220 |
| | | | Coefficient | — | 0.35 | 0.60 | 0.42 | 0.40 | 0.40 |
| | | | of dynamic | | | | | | |
| | | | friction | | | | | | |
| | | | μ′_{α} between | | | | | | |
| | | | first layer | | | | | | |
| | | | and SUS | | | | | | |

| Second layer | Raw material polymer No. | | A6 | A6 | A4 | A4 | A4 |
|---|---|---|---|---|---|---|---|
| (inorganic | Coating form | | Dots | Dots | Dots | Dots | Dots |
| filler- | Coverage area | % | 20 | 70 | 40 | 40 | 40 |
| containing | Dot diameter | μm | 220 | 220 | 220 | 220 | 220 |
| layer | Coefficient | — | 0.35 | 0.48 | 0.40 | 0.40 | 0.40 |
| surface | of dynamic | | | | | | |
| side) | friction | | | | | | |
| | μ′_{β} between | | | | | | |
| | second layer | | | | | | |
| | and Li metal | | | | | | |
| | oxide-containing | | | | | | |
| | face of positive | | | | | | |
| | electrode f | | | | | | |

| | | | | | | | |
|---|---|---|---|---|---|---|---|
| Physical | μ′_{α}/μ′_{β} | — | 1.00 | 1.25 | 1.05 | 1.00 | 1.00 |
| properties | Total thickness | μm | 17.0 | 17.0 | 8.5 | 8.5 | 5.5 |
| | MD tensile breaking strength | kgf/cm² | 1800 | 1800 | 1300 | 2000 | 1200 |
| | TD tensile breaking strength | kgf/cm² | 2100 | 2100 | 1600 | 1300 | 1500 |
| | MD/TD tensile breaking strength ratio | — | 0.86 | 0.86 | 0.81 | 1.54 | 0.80 |
| | 150° C. heat shrinkage rate | % | 6 | 6 | 2 | 2 | 2 |
| | Pin removal properties | — | D | D | D | D | D |
| | Wet adhesion | — | B | A | B | B | B |
| | Blocking property | — | C | C | A | A | A |

| | | | | | | |
|---|---|---|---|---|---|---|
| Battery | Rate characteristics | C | C | A | B | A |
| characteristics | Cycle characteristics | C | C | B | B | A |

| | | | Comp | Comp | Comp |
|---|---|---|---|---|---|
| | | | Ex 6 | Ex 7 | Ex 8 |
| Membrane | Polyolefin microporous membrane | | B1 | B1 | B1 |
| configuration | Inorganic filler- | Raw material slurry No. | C1 | C1 | C1 |

| containing layer | | Coating layer | μm | 1.5 | 1.5 | 1.5 |
|---|---|---|---|---|---|---|
| | | thickness | | | | |
| Thermoplastic | First layer | Raw material polymer No. | | A1 | A5 | A1 |
| polymer- | (porous | Coating form | | Dots | Dots | Uniform |
| containing | substrate | | | | | dispersion |
| layer | side) | Coverage area | % | 60 | 40 | 90 |
| | | Dot diameter | μm | 220 | 220 | — |
| | | Coefficient | — | 0.55 | 0.39 | 0.77 |
| | | of dynamic | | | | |
| | | friction | | | | |
| | | μ′_{α} between | | | | |
| | | first layer | | | | |
| | | and SUS | | | | |

| Second layer | Raw material polymer No. | | A5 | A5 | A1 |
|---|---|---|---|---|---|
| (inorganic | Coating form | | Dots | Dots | Uniform |
| filler- | | | | | dispersion |
| containing | Coverage area | % | 40 | 40 | 70 |
| layer | Dot diameter | μm | 220 | 220 | — |
| surface | Coefficient | — | 0.38 | 0.38 | 0.77 |
| side) | of dynamic | | | | |
| | friction | | | | |
| | μ′_{β} between | | | | |
| | second layer | | | | |
| | and Li metal | | | | |
| | oxide-containing | | | | |
| | face of positive | | | | |
| | electrode f | | | | |

| | | | | | |
|---|---|---|---|---|---|
| Physical | μ′_{α}/μ′_{β} | — | 1.45 | 1.03 | 1.00 |
| properties | Total thickness | μm | 8.5 | 8.5 | 8.5 |
| | MD tensile breaking strength | kgf/cm² | 1300 | 1300 | 1300 |
| | TD tensile breaking strength | kgf/cm² | 1600 | 1600 | 1600 |
| | MD/TD tensile breaking strength ratio | — | 0.81 | 0.81 | 0.81 |
| | 150° C. heat shrinkage rate | % | 2 | 2 | 2 |
| | Pin removal properties | — | D | D | C |
| | Wet adhesion | — | C | C | A |
| | Blocking property | — | A | A | A |

| | | | | |
|---|---|---|---|---|
| Battery | Rate characteristics | C | C | C |
| characteristics | Cycle characteristics | B | B | C |

### REFERENCE SIGNS LIST

solid line separator
dotted line positive electrode
dash-dot line negative electrode
α (light gray): μ′_{α} measurement area
β (dark gray): μ′_{β} measurement area
1 flat pin
9 pin
10 pin I
11 pin II
12 wound sample

1: A separator for an energy storage device, comprising:
a porous substrate,
an inorganic filler-containing layer arranged on only one face of the porous substrate, and
a thermoplastic polymer-containing layer arranged on a surface of the inorganic filler-containing layer, wherein
a coefficient of dynamic friction μ′_{α} between a surface on the porous substrate side and stainless steel (SUS304) and a coefficient of dynamic friction μ′_{β} between a surface on the inorganic filler-containing layer side and a lithium metal oxide-containing face of a predetermined positive electrode f satisfy the following relationship:
$${μ}_{α}^{′} / {μ}_{β}^{′} < 1. .$$

2: A separator for an energy storage device, comprising:
a porous substrate,
an inorganic filler-containing layer arranged on only one face of the porous substrate, and
thermoplastic polymer-containing layers arranged on a surface of the porous substrate and a surface of the inorganic filler-containing layer, wherein
a coefficient of dynamic friction μ′_{α} between a surface on the porous substrate side and stainless steel (SUS304) and a coefficient of dynamic friction μ′_{β} between a surface on the inorganic filler-containing layer side and a lithium metal oxide-containing face of a predetermined positive electrode f satisfy the following relationship:
$${μ}_{α}^{′} / {μ}_{β}^{′} < 1. .$$

3: The separator for an energy storage device according to claim 1, wherein μ′_{β} satisfies the following relationship:
$${μ}_{β}^{′} > 0.5 .$$

4: The separator for an energy storage device according to claim 1, wherein a thermoplastic polymer contained in the thermoplastic polymer-containing layer has a loss tangent (tan δ value) of 0.01 or more and 0.05 or less at 30° C. in dynamic viscoelasticity measurement at 1 Hz.

5: The separator for an energy storage device according to claim 1, wherein a maximum value of a loss tangent (tan δ value) of the thermoplastic polymer contained in the thermoplastic polymer-containing layer is at 70° C. or higher in dynamic viscoelasticity measurement at 1 Hz.

6: The separator for an energy storage device according to claim 1, wherein a total coverage area ratio of the thermoplastic polymer-containing layer to the porous substrate is 10% or more and 70% or less.

7: The separator for an energy storage device according to claim 1, wherein the thermoplastic polymer-containing layer is arranged in a dot-like pattern on the surface of the porous substrate and the surface of the inorganic filler-containing layer.

8: The separator for an energy storage device according to claim 1, wherein particles constituting the thermoplastic polymer-containing layer have a volume average particle diameter D₅₀ of 100 nm or more and 800 nm or less.

9: The separator for an energy storage device according to claim 1, wherein a thermoplastic polymer constituting the thermoplastic polymer-containing layer has at least two glass transition temperatures,
at least one of the glass transition temperatures is present in a region of lower than 20° C., and
at least one of the glass transition temperatures is present in a region of 30° C. or higher.

10: The separator for an energy storage device according to claim 1, wherein the thermoplastic polymer-containing layer comprises a copolymer containing a monomer unit of a (meth)acrylic acid ester monomer.

11: The separator for an energy storage device according to claim 1, wherein an inorganic filler constituting the inorganic filler-containing layer has a volume average particle diameter D₅₀ of 0.5 μm or less.

12: The separator for an energy storage device according to claim 1, wherein a ratio (MD/TD tensile breaking strength ratio) of an MD tensile breaking strength to a TD tensile breaking strength of the separator for an energy storage device is 0.5 or more and 1.5 or less.

13: The separator for an energy storage device according to claim 1, wherein a thickness of the separator for an energy storage device is 16 μm or less.

14: An energy storage device comprising a positive electrode, a negative electrode, the separator for an energy storage device according to claim 1, and a non-aqueous electrolyte solution.

15: The separator for an energy storage device according to claim 2, wherein μ′_{β} satisfies the following relationship:
$${μ}_{β}^{′} > 0.5 .$$

16: The separator for an energy storage device according to claim 2, wherein a thermoplastic polymer contained in the thermoplastic polymer-containing layer has a loss tangent (tan δ value) of 0.01 or more and 0.05 or less at 30° C. in dynamic viscoelasticity measurement at 1 Hz.

17: The separator for an energy storage device according to claim 2, wherein a maximum value of a loss tangent (tan δ value) of the thermoplastic polymer contained in the thermoplastic polymer-containing layer is at 70° C. or higher in dynamic viscoelasticity measurement at 1 Hz.

18: The separator for an energy storage device according to claim 2, wherein a total coverage area ratio of the thermoplastic polymer-containing layer to the porous substrate is 10% or more and 70% or less.

19: The separator for an energy storage device according to claim 2, wherein the thermoplastic polymer-containing layer is arranged in a dot-like pattern on the surface of the porous substrate and the surface of the inorganic filler-containing layer.

20: The separator for an energy storage device according to claim 2, wherein particles constituting the thermoplastic polymer-containing layer have a volume average particle diameter D₅₀ of 100 nm or more and 800 nm or less.

21: The separator for an energy storage device according to claim 2, wherein a thermoplastic polymer constituting the thermoplastic polymer-containing layer has at least two glass transition temperatures,
at least one of the glass transition temperatures is present in a region of lower than 20° C., and
at least one of the glass transition temperatures is present in a region of 30° C. or higher.

22: The separator for an energy storage device according to claim 2, wherein the thermoplastic polymer-containing layer comprises a copolymer containing a monomer unit of a (meth)acrylic acid ester monomer.

23: The separator for an energy storage device according to claim 2, wherein an inorganic filler constituting the inorganic filler-containing layer has a volume average particle diameter D₅₀ of 0.5 μm or less.

24: The separator for an energy storage device according to claim 2, wherein a ratio (MD/TD tensile breaking strength ratio) of an MD tensile breaking strength to a TD tensile breaking strength of the separator for an energy storage device is 0.5 or more and 1.5 or less.

25: The separator for an energy storage device according to claim 2, wherein a thickness of the separator for an energy storage device is 16 μm or less.

26: An energy storage device comprising a positive electrode, a negative electrode, the separator for an energy storage device according to claim 2, and a non-aqueous electrolyte solution.
